(19) United States
(12) Patent Application Publication
(10) Pub. No.: US 2019/0132103 A1
(43) Pub. Date: May 2, 2019

(54) METHOD AND APPARATUS FOR SENDING SOUNDING REFERENCE SIGNAL

(71) Applicant: ZTE CORPORATION, Shenzhen (CN)

(72) Inventors: Ling YANG, Shenzhen (CN); Wei GOU, Shenzhen (CN); Yajun ZHAO, Shenzhen (CN); Focai PENG, Shenzhen (CN)

(21) Appl. No.: 16/070,883

(22) PCT Filed: Jan. 18, 2017
(86) PCT No.: PCT/CN2017/071482

§ 371 Date: Jan. 7, 2019

(30) Foreign Application Priority Data
Jan. 20, 2016 (CN) 201610037277.0

(51) Int. Cl. H04L 5/00; H04W 72/04; H04W 72/12

(52) U.S. Cl. CPC H04L 5/0051; H04W 72/0446; H04W 72/121; H04L 5/0037; H04W 72/042

(57) ABSTRACT

The present invention relates to the field of wireless communications. Disclosed are a method and apparatus for sending a sounding reference signal. The method comprises: contending for a use permission of an unlicensed carrier according to listen-before-talk (LBT) or clear channel assessment (CCA) detection; and when the use permission of the unlicensed carrier is successfully contended, sending a sounding reference signal (SRS) on the unlicensed carrier. A method for transmitting an SRS and a PUSCH simultaneously or not simultaneously and a method for sending SRSs at part of uplink subframes are provided, and more SRS sending opportunities are provided. In downlink transmission, an SRS sequence is used as an occupied signal, thereby simplifying design of the occupied signal.

### TECHNICAL FIELD

Embodiments of the disclosure relate to the field of wireless communication, and particularly to a method and device for sending a sounding reference signal (SRS).

### BACKGROUND

Along with rapid increase of data services, data transmission pressure on a carrier of a licensed spectrum keeps increasing. Therefore, offloading data traffic in a licensed carrier through a carrier of an unlicensed spectrum becomes an important evolution direction for subsequent development of long term evolution (LTE).

An unlicensed spectrum has the following characteristics: the unlicensed spectrum is not required to be purchased, is zero in spectrum resource cost and has the characteristic of no/low charge; both an individual and an enterprise may participate in deployment, equipment of an equipment manufacturer may be freely deployed, and the unlicensed spectrum has the characteristics of low access requirement and low cost; frequency bands of 5 GHz, 2.4 GHz and the like in the unlicensed spectrum are all available, and the unlicensed spectrum has the characteristic of large available bandwidth; and an unlicensed carrier has the characteristic of resource sharing, that is, when multiple different systems operate therein or different operators of the same system operate therein, some resource sharing manners may be considered to improve spectrum utilization efficiency and the like.

A project for researches on Release-13 (Rel-13) of LTE system was set up in September, 2014, and an important research issue is use of carriers of unlicensed spectrums for work of the LTE system. This technology may make an existing carrier of an unlicensed spectrum available for the LTE system, greatly improve potential spectrum resources of the LTE system and enable the LTE system to achieve lower spectrum cost.

In the LTE system, SRS is a basic Uplink (UL) function, and an eNodeB (eNB) estimates UL channel quality of different frequency bands by use of the SRS. A scheduler of the eNB may allocate resource blocks (RBs) in good transient channel states for physical uplink shared channel (PUSCH) transmission of user equipment (UE) according to UL channel state estimation. In addition, the SRS may also be used for fixing UL timing, and under the assumption that a downlink channel and an UL channel are reciprocal, downlink channel quality is estimated by use of channel symmetry, particularly in a time division duplex (TDD) system.

Similar to the LTE system, in a licensed assisted access (LAA) system, it is also required to send the SRS. However, because of own characteristics of the LAA system, before an unlicensed carrier is used for transmission, it is necessary to execute a listen before talk (LBT) mechanism to acquire a right to use the unlicensed carrier at first according to a control requirement. Similarly, before sending an SRS on the unlicensed carrier, UE is also required to execute the LBT mechanism at first. If the unlicensed carrier is allowed to be used, the following problems are required to be considered:

1: how to send an SRS in case that the SRS and a PUSCH are simultaneously transmitted;

2: how to send the SRS in case that the SRS and the PUSCH are unsimultaneously transmitted;

3: for LAA downlink, how to send an SRS sequence by an eNB;

4: how to multiplex a resource between multiple UEs to send SRSs; and

5: how to send an SRS by UE in case that UL partial subframe.

If the unlicensed carrier is not allowed to be used, the following problem is required to be considered: how to increase an SRS sending opportunity of UE after the UE fails to execute LBT.

If the above problems cannot be solved well, UL transmission timing in an unlicensed carrier may be directly influenced, and UL frequency-selective scheduling of an eNB (allocation of a resource in a relatively good channel state for UL transmission), determination of a modulation and coding scheme (MCS) and the like may not be ensured.

### SUMMARY

The below is a summary about a theme described in the disclosure in detail. The summary is not intended to limit the protection scope of the claims.

For solving technical problems about sending of an SRS on an unlicensed carrier, the embodiments of the disclosure disclose a method and device for sending an SRS, so as to implement SRS sending methods for the conditions of simultaneous or unsimultaneous transmission of an SRS and a PUSCH and an UL partial subframe and also provide more SRS sending opportunities.

In order to achieve the purpose of the disclosure, the embodiments of the disclosure provide a method for sending an SRS, which is applied to a first communication node and includes that:

a right to use an unlicensed carrier is contended for according to an LBT or clear channel assessment (CCA) detection; and

when the contention for the right to use the unlicensed carrier is successful, at least one of an SRS or a PUSCH is sent on the unlicensed carrier.

In some embodiments, when the SRS is sent on the unlicensed carrier, a location for sending the SRS may include a specific symbol in a time unit.

In some embodiments, the time unit may include at least one of: a subframe or a time slot.

In some embodiments, when the time unit is a subframe or a time slot, the specific symbol may include at least one of:

a first orthogonal frequency division multiplexing (OFDM) symbol or a last OFDM symbol.

In some embodiments, the location for sending the SRS may include a time window for sending the SRS.

In some embodiments, the time window for sending the SRS may be located before the time unit or after the time unit or may include the time unit.

In some embodiments, the location for sending the SRS in the time window may be determined by at least one of the following parameters:

an offset in the time window, a number of SRS durations, an interval between the SRS durations, a duration of the time window or an ending location of the SRS duration in the time window.

In some embodiments, the SRS duration may include at least one of: a subframe, multiple subframes, a time slot or multiple time slots.

In some embodiments, the SRS may be sent on at least one symbol in the SRS duration in the time window for sending SRS.

In some embodiments, the location for sending the SRS may be determined in one of the following manners:

determining the location for sending the SRS according to a moment at which the LBT is executed successfully;

indicating the location for sending the SRS by an eNB through physical-layer downlink control information (DCI);

indicating the location for sending the SRS on multiple continuous subframes by the eNB through the physical-layer DCI;

indicating the location for sending the SRS on each subframe by the eNB; and

determining as a default that the SRS can be sent on a candidate subframe, the specific candidate subframe for sending the SRS being required to be indicated or triggered through signaling sent by the eNB.

In some embodiments, when the SRS is sent on the unlicensed carrier, the location for sending the SRS may include at least one of:

an uplink pilot time slot (UpPTS) in a special subframe or a guard period (GP) in the special subframe.

In some embodiments, when the SRS is sent on the unlicensed carrier, the location for sending the SRS may be in a duration during which the eNB sends a reservation signal.

In some embodiments, the duration for sending the reservation signal may include a time period from successful execution of CCA or LBT by the eNB to starting of downlink transmission.

In some embodiments, when the SRS is sent on the unlicensed carrier, the location for sending the SRS may be in a downlink transmission period.

In some embodiments, a location of a subframe for sending the SRS in the downlink transmission period may be determined in at least one of the following manners: indicating the location of the subframe for sending the SRS by the eNB through the physical-layer DCI; predefining the location of the subframe for sending the SRS; or predetermining the location of the subframe for sending the SRS by the eNB and UE.

In some embodiments, when the SRS is sent on the unlicensed carrier, the location for sending the SRS may be in a discovery reference signal (DRS) transmission period.

In some embodiments, the operation of sending the SRS in the DRS transmission period may include: sending the SRS on an idle symbol in a subframe for sending DRS.

In some embodiments, the idle symbol may include at least one of:

a thirteenth symbol, a fourteenth symbol or an idle symbol determined according to a DRS pattern.

In some embodiments, when the SRS is sent on the unlicensed carrier, the location for sending the SRS may include a last partial subframe after downlink transmission is ended.

In some embodiments, a location of the symbol for sending the SRS on the last partial subframe after the downlink transmission is ended may be indicated by the eNB through the physical-layer DCI, or determined according to the moment at which the LBT or CCA is executed successfully or predefined.

In some embodiments, when the PUSCH is sent on the unlicensed carrier, a starting location of the PUSCH may be a specific symbol on a time unit.

In some embodiments, the time unit may include at least one of: a subframe, a time slot or a symbol.

In some embodiments, the specific symbol may include at least one of: a symbol 0, a symbol 1, a symbol 4 or a symbol 7.

In some embodiments, the starting location of the PUSCH may further include:

a transmission moment of the PUSCH is completely determined according to the moment at which the LBT or CCA is executed successfully.

In some embodiments, a location for executing the LBT or CCA detection may include one of the following:

the location for executing the LBT or CCA detection is limited in a predetermined region; or,

the location for executing the LBT or CCA detection is not limited.

In some embodiments, when the location for executing the LBT or CCA detection is limited in the predetermined region, the location for executing the LBT or CCA detection may include one of:

last k OFDM symbols in a previous subframe of a subframe or a scheduling subframe;

first s OFDM symbols in the subframe or the scheduling subframe; or last k1 OFDM symbols in the previous subframe of the subframe or the scheduling subframe and first s1 OFDM symbols in the subframe or the scheduling subframe, where k, s, k1 and s1 may be positive integers.

In some embodiments, the parameter k and the parameter s may both be 1 or 2, and the parameter k1 and the parameter s1 may both be 1.

In some embodiments, when the LBT or CCA is successfully executed on a last OFDM symbol in the previous subframe of the subframe or the scheduling subframe, the method may include that:

the PUSCH and the SRS are sent on the subframe or the scheduling subframe.

In some embodiments, a transmission starting moment of the PUSCH may include a first OFDM symbol in the scheduling subframe.

In some embodiments, the location for sending the SRS may include a last OFDM symbol in the scheduling subframe.

In some embodiments, when the location for sending the SRS and a location for executing the LBT or CCA detection of a next subframe are in the same OFDM symbol, the following condition may be included:

the location for sending the SRS and the location for executing the LBT or CCA detection of the next subframe coexist in a frequency division manner.

In some embodiments, a frequency-domain location for sending the SRS may include a frequency-domain resource corresponding to a predetermined subcarrier spacing on the whole bandwidth.

In some embodiments, the predetermined subcarrier spacing may be 1 or 3.

In some embodiments, the location of LBT or CCA detection may be one of frequency-domain location sets of the SRS.

In some embodiments, the method may further include that: the location for sending the SRS is modified.

In some embodiments, the location for sending the SRS may include: a first OFDM symbol in the subframe; or, a last OFDM symbol of a first half time slot in the subframe; or, a first OFDM symbol of a second half time slot in the subframe.

In some embodiments, after LBT or CCA is successfully executed on the last OFDM symbol in the previous subframe of the scheduling subframe, the method may further include that:

first UE or UE group sends the PUSCH on the scheduling subframe, and second UE or UE group sends the SRS on a last symbol in the scheduling subframe or the candidate subframe;

or,

the first UE or UE group, sends the PUSCH on the scheduling subframe or the candidate subframe and second UE or UE group sends the SRS on the last symbol of the subframe; or

the first UE or UE group sends the PUSCH on the scheduling subframe or the candidate subframe and sends the SRS on the last symbol of the subframe; or

the first UE or UE group sends the PUSCH on the scheduling subframe or the candidate subframe and both the second UE or UE group and the first UE or UE group send the SRS on the last symbol of the subframe.

In some embodiments, after LBT or CCA is successfully executed on the last symbol in the previous subframe of the scheduling subframe, the method may further include that:

the first UE or UE group sends the PUSCH on the scheduling subframe, and the second UE or UE group sends the SRS on a first symbol in the scheduling subframe or the candidate subframe;

or,

the first UE or UE group sends the PUSCH on the scheduling subframe or the candidate subframe and the second UE or UE group sends the SRS on the first symbol of the subframe; or,

the first UE or UE group sends the PUSCH on the scheduling subframe or the candidate subframe and sends the SRS on the first symbol of the subframe; or,

the first UE or UE group sends the PUSCH on the scheduling subframe or the candidate subframe and both the second UE or UE group and the first UE or UE group send the SRS on the first symbol of the subframe.

In some embodiments, before the operation that the second UE or UE group sends the SRS, the method may further include that: a reservation signal is sent in a blank between the moment at which the LBT or CCA is executed successfully and the location for sending the SRS.

In some embodiments, before the operation that the second UE or UE group sends the SRS, the method may further include that: LBT or CCA detection is executed; or, LBT or CCA detection is not executed.

In some embodiments, a location for executing the LBT or CCA detection for SRS sending of the second UE or UE group may include an OFDM symbol before the location of the SRS.

In some embodiments, for LBT or CCA detection executed for SRS sending of the second UE or UE group, a simplified LBT mechanism or parameter configuration may be executed.

In some embodiments, an LBT or CCA operation may be determined not to be executed for SRS sending of the second UE or UE group in one of the following manners:

determining to send the SRS on the candidate subframe according to an indication of the eNB;

determining whether to send the SRS or not according to an indication of the eNB on each subframe; or,

determining as a default to send the SRS on the candidate subframe and determining the subframe for sending the SRS according to the indication of the eNB or triggering of new signaling.

In some embodiments, the SRS may be independently sent according to a 1 ms control requirement or the SRS may be independently sent regardless of the 1 ms control requirement.

In some embodiments, after LBT or CCA detection is successfully executed, when the SRS is sent according to the 1 ms control transmission requirement, the method may include that: the SRS is sent at a predetermined time-domain location and the reservation signal is sent on other time-domain resources.

In some embodiments, the predetermined time-domain location may include one of: the last OFDM symbol of the subframe; or, the first OFDM symbol of the subframe; or, the last OFDM symbol of the first half time slot in the subframe; or, the first OFDM symbol of the second half time slot in the subframe; or, a first OFDM symbol immediately following the moment at which the LBT or CCA detection is executed successfully.

In some embodiments, the reservation signal may be an SRS.

In some embodiments, after LBT or CCA detection is successfully executed, when the SRS is sent regardless of the 1 ms control transmission requirement, the method may include that: the SRS is sent on the first OFDM symbol immediately following the moment at which the LBT or CCA detection is executed successfully.

In some embodiments, when the first communication node is the eNB, the operation that the SRS is sent may further include one of the following operations:

the SRS is sent on an idle symbol in a DRS time-domain pattern composition;

the SRS is sent in an initial signal or reservation signal sending stage; or

the SRS is sent in the downlink transmission period.

In some embodiments, the method may further include that:

when the right to use the unlicensed carrier is not obtained by contention, the SRS is stopped to be sent on a first predetermined time-domain resource, LBT or CCA detection is executed before a second predetermined time-domain resource after the first predetermined time-domain resource of the unlicensed carrier, and when the LBT is successfully executed before the second predetermined time-domain resource, the SRS is sent on the second predetermined time-domain resource; or,

when the right to use the unlicensed carrier is not obtained by contention, the SRS is stopped to be sent on the first predetermined time-domain resource, LBT or CCA detection is executed before a third predetermined time-domain resource in the time window configured to send the SRS on the unlicensed carrier, and when the LBT is successfully executed before the third predetermined time-domain resource, the SRS is sent on the third predetermined time-domain resource; or,

when the right to use the unlicensed carrier is not obtained by contention, the SRS is stopped to be sent on the first predetermined time-domain resource, contention for the right to use the unlicensed carrier is continued on the unlicensed carrier, and when the unlicensed carrier is obtained by contention, the SRS is sent.

In some embodiments, a complemental location for sending the SRS may be located

before the first predetermined time-domain resource or after the first predetermined time-domain resource or may include the first predetermined time-domain resource.

In some embodiments, when LBT or CCA is successfully executed on the first s OFDM symbols in the subframe or the scheduling subframe or the last k1 OFDM symbols in the previous subframe of the subframe or the scheduling subframe and the s1 OFDM symbols in the subframe or the scheduling subframe, the method may include that:

the PUSCH is started from a symbol s+1; or,

the PUSCH is started from a symbol s1+1, where s, s1 and k1 may be positive integers.

In some embodiments, the location for sending the SRS may include one of:

the last OFDM symbol of the subframe; or,

the first OFDM symbol of the subframe; or,

the last OFDM symbol of the first half time slot in the subframe; or,

the first OFDM symbol of the second half time slot in the subframe; or,

the first OFDM symbol immediately following the moment at which the LBT or CCA detection is executed successfully; or,

a first OFDM symbol where the PUSCH is started to be transmitted.

In some embodiments, at least one of a time-domain location for executing LBT or CCA detection, a frequency-domain location for executing LBT or CCA detection, a time-domain location for sending the SRS, a frequency-domain location for sending the SRS, a location of the time window for sending the SRS, a candidate time-domain location for sending the SRS, a candidate frequency-domain location for sending the SRS, or the transmission starting moment of the PUSCH may be acquired in the following manners:

predetermining by the eNB and the UE; or,

indicating to the UE by the eNB; or,

notifying through physical-layer signaling, for example, DCI; or,

notifying through high-layer Radio Resource Control (RRC) signaling; or,

predefining.

In some embodiments, an LBT mechanism executed to send the SRS or a size of a contention window (CW) of the LBT mechanism may be regulated according to the number of times for which LBT is failed to be executed to send the SRS, where a regulation indication may include notifying the UE for regulation by the eNB or regulation by the UE.

The embodiments of the disclosure further provide a device for sending an SRS, which is arranged in a first communication node and includes:

a contention module, configured to contend for a right to user an unlicensed carrier according to LBT or CCA detection; and

a sending module, configured to, when the contention for the right to use the unlicensed carrier is successful, send at least one of an SRS or a PUSCH on the unlicensed carrier.

In some embodiments, when the SRS is sent on the unlicensed carrier, a location for sending the SRS may include a specific symbol in a time unit;

when the SRS is sent on the unlicensed carrier, the location for sending the SRS may further include a time window for sending an SRS;

when the SRS is sent on the unlicensed carrier, the location for sending the SRS may include at least one of: an UpPTS in a special subframe or a GP in the special subframe;

when the SRS is sent on the unlicensed carrier, the location for sending the SRS may be in a duration during which an eNB sends a reservation signal;

when the SRS is sent on the unlicensed carrier, the location for sending the SRS may be in a downlink transmission period.

when the SRS is sent on the unlicensed carrier, the location for sending the SRS may be in a DRS transmission period;

when the SRS is sent on the unlicensed carrier, the location for sending the SRS may include a last partial subframe after downlink transmission is ended;

when the PUSCH is sent on the unlicensed carrier, a starting location of the PUSCH may include a specific symbol on a time unit; and

when the PUSCH is sent on the unlicensed carrier, the starting location of the PUSCH may further include: a transmission moment of the PUSCH is completely determined by a moment at which the LBT or CCA is executed successfully.

In some embodiments, the device may further include: a regulation module, configured to modify the location for sending the SRS.

In some embodiments, after the contention module successfully executes LBT or CCA on a last OFDM symbol in a previous subframe of a scheduling subframe, the sending module may further be configured to:

send, by first UE or UE group, the PUSCH on the scheduling subframe and send, by second UE or UE group, the SRS on a last symbol in the scheduling subframe or a candidate subframe; or,

send, by first UE or UE group, the PUSCH on the scheduling subframe or the candidate subframe and send, by second UE or UE group, the SRS on the first symbol of the subframe; or

send, by first UE or UE group, the PUSCH on the scheduling subframe or the candidate subframe and send, by the first UE or UE group, the SRS on the first symbol of the subframe; or

send, by first UE or UE group, the PUSCH on the scheduling subframe or the candidate subframe and send, by both second UE or UE group and the first UE or UE group, the SRS on the first symbol of the subframe.

In some embodiments, after the contention module successfully executes LBT or CCA on the last OFDM symbol in the previous subframe of the scheduling subframe, the sending module may further be configured to:

send, by the first UE or UE group, the PUSCH on the scheduling subframe and send, by the second UE or UE group, the SRS on the scheduling subframe or a first symbol in the candidate subframe; or,

send, by first UE or UE group, the PUSCH on the scheduling subframe or the candidate subframe and send, by second UE or UE group, the SRS on the first symbol of the subframe; or,

send, by first UE or UE group, the PUSCH on the scheduling subframe or the candidate subframe and send, by the first UE or UE group, the SRS on the first symbol of the subframe; or,

send, by first UE or UE group, the PUSCH on the scheduling subframe or the candidate subframe and send, by both second UE or UE group and the first UE or UE group, the SRS on the first symbol of the subframe.

In some embodiments, when the first communication node is the eNB, the operation that the sending module sends the SRS may further include one of:

sending the SRS on an idle symbol in a DRS time-domain pattern composition;

sending the SRS in an initial signal or reservation signal sending stage; and

sending the SRS in the downlink transmission period.

In some embodiments, the sending module may further be configured to:

when the right to use the unlicensed carrier is not obtained by contention, stop sending the SRS on a first predetermined time-domain resource, execute LBT or CCA detection before a second predetermined time-domain resource after the first predetermined time-domain resource of the unlicensed carrier, and when LBT is successfully executed before the second predetermined time-domain resource, send the SRS on the second predetermined time-domain resource; or,

when the right to use the unlicensed carrier is not obtained by contention, stop sending the SRS on a first predetermined time-domain resource, execute LBT or CCA detection before a third predetermined time-domain resource in a time window configured to send the SRS on the unlicensed carrier, and when the LBT is successfully executed before the third predetermined time-domain resource, send the SRS on the third predetermined time-domain resource; or,

when the right to use the unlicensed carrier is not obtained by contention, stop sending the SRS on the first predetermined time-domain resource, continue contending for the right to use the unlicensed carrier on the unlicensed carrier, and when the unlicensed carrier is obtained by contention, complementally send the SRS.

In some embodiments, the regulation module may be configured to regulate an LBT mechanism executed to send the SRS or a size of a CW of the LBT mechanism according to a number of times for which LBT is failed to be executed to send the SRS, wherein a regulation indication may include notifying UE for regulation by the eNB or regulation by the UE.

In addition, the embodiments of the disclosure further provide a computer-readable storage medium, which stores a computer-executable instruction, the computer-executable instruction being configured to execute any abovementioned method for sending an SRS.

Compared with the prior art, the embodiments of the disclosure have the following beneficial effects.

According to the method and device of the embodiments of the disclosure, SRS sending methods for the conditions of simultaneous or unsimultaneous transmission of an SRS and a PUSCH and an UL partial subframe are provided, and more SRS sending opportunities are also provided. For downlink transmission, an SRS sequence is adopted as an occupancy signal, thereby simplifying design of the occupancy signal.

Other characteristics and advantages of the embodiments of the disclosure will be elaborated in the following specification and, moreover, partially become apparent from the specification or are understood by implementing the disclosure. The purpose and other advantages of the disclosure may be achieved and obtained through structures particularly pointed out in the specification, the claims and the drawings.

After the drawings and detailed descriptions are read and understood, the other aspects may be comprehended.

### BRIEF DESCRIPTION OF DRAWINGS

The drawings described herein are intended to provide a further understanding to the disclosure and form a part of the application. Schematic embodiments of the disclosure and descriptions thereof are adopted to explain the disclosure and not intended to form improper limits to the disclosure. In the drawings:

FIG. 1 is a flowchart of a method for sending an SRS according to an embodiment of the disclosure.

FIG. 2 is a structure diagram of a device for sending an SRS according to an embodiment of the disclosure.

FIG. 3 is a schematic diagram of a location for executing LBT or CCA in first s OFDM symbols in a scheduling subframe according to an embodiment of the disclosure.

FIG. 4 is a schematic diagram of a location for executing LBT or CCA in last k1 OFDM symbols in a previous subframe of a scheduling subframe and s1 OFDM symbols in the scheduling subframe according to an embodiment of the disclosure.

FIG. 5 is a schematic diagram of multiplexing and respective SRS sending of multiple users in the case of a multi-subframe scheduling according to an embodiment of the disclosure.

FIG. 6 is a first schematic diagram of multiplexing transmission of an SRS and a PUSCH of other UEs according to an embodiment of the disclosure.

FIG. 7 is a second schematic diagram of multiplexing transmission of an SRS and a PUSCH of other UEs according to an embodiment of the disclosure.

FIG. 8 is a third schematic diagram of multiplexing transmission of an SRS and a PUSCH of other UEs according to an embodiment of the disclosure.

FIG. 9 is a fourth schematic diagram of multiplexing transmission of an SRS and a PUSCH of other UEs according to an embodiment of the disclosure.

FIG. 10 is a first schematic diagram of independent sending of an SRS by UE according to an embodiment of the disclosure.

FIG. 11 is a second schematic diagram of independent sending of an SRS by UE according to an embodiment of the disclosure.

FIG. 12 is a third schematic diagram of independent sending of an SRS by UE according to an embodiment of the disclosure.

FIG. 13 is a schematic diagram of an SRS frequency-domain pattern with a subcarrier spacing of 1 according to an embodiment of the disclosure.

FIG. 14 is a schematic diagram of an SRS frequency-domain pattern with a subcarrier spacing of 3 according to an embodiment of the disclosure.

FIG. 15 is a schematic diagram of a time window for sending an SRS after a present SRS period point and before a next SRS period point according to an embodiment of the disclosure.

FIG. 16 is a schematic diagram of a time window for sending an SRS with multiple continuous SRS sending opportunity points according to an embodiment of the disclosure.

FIG. 17 is a schematic diagram of a time window for sending an SRS with multiple discrete SRS sending opportunity points according to an embodiment of the disclosure.

FIG. 18 is a schematic diagram of sending an SRS in a manner of combining a short period and a long period according to an embodiment of the disclosure.

### DETAILED DESCRIPTION

The disclosure will be described below with reference to the drawings and in combination with the embodiments in detail. It is to be noted that the embodiments in the application and characteristics in the embodiments may be combined without conflicts.

It is to be noted that terms “first”, “second” and the like in the specification, claims and drawings of the disclosure are adopted not to describe a specific sequence or order but to distinguish similar objects.

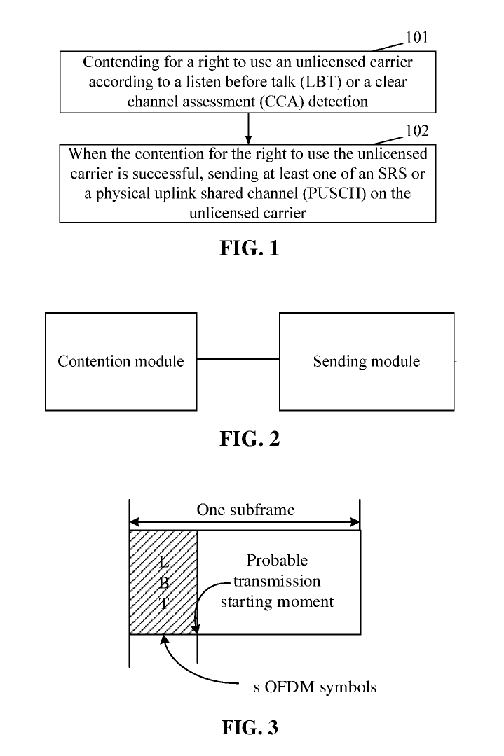

As illustrated in FIG. 1, an embodiment of the disclosure provides a method for sending a sounding reference signal (SRS), which is applied to a first communication node and includes the following operations.

In 101, a right to use an unlicensed carrier is contented for according to LBT or CCA detection.

In 102, when the contention for the right to use the unlicensed carrier is successful, at least one of an SRS or a PUSCH is sent on the unlicensed carrier.

In some embodiments, when the SRS is sent on the unlicensed carrier, a location for sending the SRS includes a specific symbol in a time unit.

Here, the time unit includes at least one of: a subframe or a time slot.

When the time unit is a subframe or a time slot, the specific symbol includes at least one of:

a first OFDM symbol or a last OFDM symbol.

In some embodiments, the location for sending the SRS further includes a time window for sending the SRS.

The SRS sending time window is located before the time unit or after the time unit or includes the time unit.

The location for sending the SRS in the time window is determined by at least one of the following parameters:

an offset in the time window, a number of SRS durations, an interval between the SRS durations, a duration of the time window or an ending location of the SRS duration in the time window.

The SRS duration includes at least one of: a subframe, multiple subframes, a time slot or multiple time slots.

The SRS is sent on at least one symbol in the SRS duration in the SRS sending time window.

Here, the operation of determining the location for sending the SRS includes one of the following:

determining the location for sending the SRS according to a moment at which the LBT is executed successfully;

indicating the location for sending the SRS by an eNB through physical-layer DCI;

indicating the location for sending the SRS on multiple continuous subframes by the eNB through the physical-layer DCI;

indicating the location for sending the SRS on each subframe by the eNB; or

determining as a default that the SRS can be sent on a candidate subframe, the specific candidate subframe for sending the SRS being required to be indicated or triggered through signaling sent by the eNB.

In some embodiments, when the SRS is sent on the unlicensed carrier, the location for sending the SRS includes at least one of:

an UpPTS in a special subframe or a GP in the special subframe.

In some embodiments, when the SRS is sent on the unlicensed carrier, the location for sending the SRS is in a duration during which the eNB sends a reservation signal.

Here, the duration for the reservation signal includes a time period from successful execution of CCA or LBT by the eNB to starting of downlink transmission.

In some embodiments, when the SRS is sent on the unlicensed carrier, the location for sending the SRS is in a downlink transmission period.

A location of subframe for sending the SRS in the downlink transmission period is determined in at least one of the following manners: indicating by the eNB through the physical-layer DCI; predefining; or predetermining by the eNB and UE.

In some embodiments, when the SRS is sent on the unlicensed carrier, the location for sending the SRS is in a DRS transmission period.

Here, sending of the SRS in the DRS transmission period includes: sending on an idle symbol in a DRS subframe.

The idle symbol includes at least one of:

a thirteenth symbol, a fourteenth symbol or an idle symbol determined according to a DRS pattern.

In some embodiments, when the SRS is sent on the unlicensed carrier, the location for sending the SRS may include a last partial subframe after downlink transmission is ended.

An SRS sending symbol location on the last partial subframe after the downlink transmission is ended is indicated by the eNB through the physical-layer DCI, or determined according to the moment at which the LBT or CCA is executed successfully or predefined.

In some embodiments, when the PUSCH is sent on the unlicensed carrier, a starting location of the PUSCH includes the following condition:

the starting location of the PUSCH is a specific symbol on a time unit.

The time unit includes at least one of: a subframe, a time slot or a symbol.

The specific symbol includes at least one of: a symbol 0, a symbol 1, a symbol 4 or a symbol 7.

The starting location of the PUSCH further includes the following condition:

a transmission moment of the PUSCH is completely determined by the moment at which the LBT or CCA is executed successfully

The operation that the SRS is sent includes one of the following operations:

the SRS and the PUSCH are simultaneously transmitted on the unlicensed carrier;

the SRS and PUSCHs of other UEs are simultaneously transmitted on the unlicensed carrier; or

the SRS is independently transmitted on the unlicensed carrier.

A manner for sending the SRS includes:

periodically sending and/or aperiodically triggering sending the SRS on the unlicensed carrier.

A location for executing LBT or CCA detection includes one of the following:

the location of LBT or CCA detection is limited in a predetermined region; or,

the location of LBT or CCA detection is not limited.

When the location of LBT or CCA detection is limited in the predetermined region, the execution location of LBT or CCA detection includes one of:

last k OFDM symbols in a previous subframe of a subframe or a scheduling subframe; or,

first s OFDM symbols in the subframe or the scheduling subframe; or,

last k1 OFDM symbols in the previous subframe of the subframe or the scheduling subframe and first s1 OFDM symbols in the subframe or the scheduling subframe,

where k, s, k1 and s1 are positive integers.

In some embodiments, k and s are both 1 or 2, and k1 and s1 are both 1.

When LBT or CCA is successfully executed on a last OFDM symbol in the previous subframe of the subframe or the scheduling subframe, the method includes that:

the PUSCH and the SRS are sent on the subframe or the scheduling subframe.

A transmission starting moment of the PUSCH includes a first OFDM symbol in the scheduling subframe.

The location for sending the SRS includes a subframe location or a symbol location and specifically includes a last OFDM symbol in the scheduling subframe in the embodiment of the disclosure.

When the location for sending the SRS and an execution location of LBT or CCA detection of next subframe are in the same OFDM symbol, the following condition is included:

the location for sending the SRS and the execution location of LBT or CCA detection of the next subframe coexist in a frequency division manner.

A frequency-domain location for sending the SRS includes a frequency-domain resource corresponding to a predetermined subcarrier spacing on the whole bandwidth.

The predetermined subcarrier spacing includes: a subcarrier spacing of 1 or a subcarrier spacing of 3.

The location of LBT or CCA detection is a location in a frequency-domain location set of the SRS.

The method further includes that: the location for sending the SRS is modified.

The location for sending the SRS includes: a first OFDM symbol in the subframe; or, a last OFDM symbol of a first half time slot in the subframe; or, a first OFDM symbol of a second half time slot in the subframe.

The SRS sent by the UE and the PUSCH of the other UEs are transmitted in a multiplexing manner or simultaneously, and after LBT or CCA is successfully executed on the last OFDM symbol in the previous subframe of the scheduling subframe, the method further includes that:

first UE or UE group sends the PUSCH on the scheduling subframe, and second UE or UE group sends the SRS on the scheduling subframe or a last symbol in a candidate subframe;

or,

the first UE or UE group, sends the PUSCH on the scheduling subframe or the candidate subframe and second UE or UE group sends the SRS on the last symbol of the subframe; or

the first UE or UE group sends the PUSCH on the scheduling subframe or the candidate subframe and sends the SRS on the last symbol of the subframe; or

the first UE or UE group sends the PUSCH on the scheduling subframe or the candidate subframe and both the second UE or UE group and the first UE or UE group send the SRS on the last symbol of the subframe.

After LBT or CCA is successfully executed on the last symbol in the previous subframe of the scheduling subframe, the method further includes that:

the first UE or UE group sends the PUSCH on the scheduling subframe, and the second UE or UE group sends the SRS on the scheduling subframe or a first symbol in the candidate subframe;

or,

the first UE or UE group sends the PUSCH on the scheduling subframe or the candidate subframe and the second UE or UE group sends the SRS on the first symbol of the subframe; or,

the first UE or UE group sends the PUSCH on the scheduling subframe or the candidate subframe and sends the SRS on the first symbol of the subframe; or,

the first UE or UE group sends the PUSCH on the scheduling subframe or the candidate subframe and both the second UE or UE group and the first UE or UE group send the SRS on the first symbol of the subframe.

Before the operation that the second UE or UE group sends the SRS, the method further includes that: a reservation signal is sent in a blank between the moment at which the LBT or CCA is executed successfully and the location for sending the SRS.

Before the operation that the second UE or UE group sends the SRS, the method further includes that: LBT or CCA detection is executed; or, LBT or CCA detection is not executed.

An execution location of LBT or CCA detection for SRS sending of the second UE or UE group includes an OFDM symbol before the location of the SRS.

For LBT or CCA detection executed for SRS sending of the second UE or UE group, a simplified LBT mechanism or parameter configuration is executed.

An LBT or CCA operation is determined not to be executed for SRS sending of the second UE or UE group in one of the following manners:

determining to send the SRS on the candidate subframe according to an indication of the eNB; or,

determining whether to send the SRS or not according to an indication of the eNB on each subframe; or,

determining as a default to send the SRS on the candidate subframe and determining the subframe for sending the SRS according to the indication of the eNB or triggering of new signaling.

The SRS is independently sent according to a 1 ms control requirement or the SRS is independently sent regardless of the 1 ms control requirement.

After LBT or CCA detection is successfully executed, when the SRS is sent according to the 1 ms control transmission requirement, the method includes that: the SRS is sent at a predetermined time-domain location and the reservation signal is sent on other time-domain resources.

The predetermined time-domain location includes one of: the last OFDM symbol of the subframe; or, the first OFDM symbol of the subframe; or, the last OFDM symbol of the first half time slot in the subframe; or, the first OFDM symbol of the second half time slot in the subframe; or, a first OFDM symbol after the moment at which the LBT or CCA detection is executed successfully.

The reservation signal is an SRS.

After LBT or CCA detection is successfully executed, when the SRS is sent regardless of the 1 ms control transmission requirement, the method includes that: the SRS is sent on the first OFDM symbol immediately following the moment at which the LBT or CCA detection is executed successfully.

When the first communication node is the eNB, the operation that the SRS is sent further includes one of the following operations:

the SRS is sent on an idle symbol in a DRS time-domain pattern composition;

the SRS is sent in an initial signal or reservation signal sending stage; and

the SRS is sent in the downlink transmission period.

After the UE executes LBT/CCA detection to successfully contend for the unlicensed carrier, an independent sending manner for the SRS includes one of:

repeatedly sending the SRS until a continuous time-domain length meets a control requirement, for example, 1 ms; or,

sending, by the UE, the SRS on a first symbol immediately following the moment at which the LBT or CCA detection is executed successfully; here, a frequency-domain composition of the symbol includes one of: the SRS and an LBT/CCA detection pattern; or, the SRS, the LBT/CCA detection pattern and others idle resources. The LBT/CCA detection pattern is shared by UEs of the same cell or the same operator. UE continuing detection performs CCA on a common LBT/CCA resource, and if an assessment result is idle, the UE sends its own SRS on a resource except the common LBT/CCA resource or LBT/CCA and the reservation signal in a frequency domain in a next symbol. If a channel is assessed to be busy, it is determined that the channel is unavailable, and LBT/CCA may be continued, or, detection is stopped. UE occupying the channel first is required to keep sending a reservation signal, and the reservation signal may be an SRS or other information. In addition, a frequency-domain location of the reservation signal may be the same as or different from that of the SRS. The UE continuing detection may send no occupancy signal or send an occupancy signal. That is, time that UE continuously occupies the channel meets the control requirement, or, total time that multiple pieces of multiplexing UE occupy the channel meets the control requirement.

Under the condition that independent occupation of a piece of UE meets a duration defined by the control requirement, the UE sends an SRS on a specific symbol after the success moment of LBT/CCA, and a physical uplink control channel (PUCCH) or an occupancy signal or a reservation signal may be sent on other symbols in the duration defined by the control requirement.

The method further includes that:

when the right to use the unlicensed carrier is not obtained by contention, the UE stops sending the SRS on a first predetermined time-domain resource, executes LBT or CCA detection before a second predetermined time-domain resource after the first predetermined time-domain resource of the unlicensed carrier, and under the condition that LBT is successfully executed before the second predetermined time-domain resource, sends the SRS on the second predetermined time-domain resource; or,

when the right to use the unlicensed carrier is not obtained by contention, the UE stops sending the SRS on the first predetermined time-domain resource, executes LBT or CCA detection before a third predetermined time-domain resource in the time window configured to send the SRS on the unlicensed carrier, and under the condition that LBT is successfully executed before the third predetermined time-domain resource, sends the SRS on the third predetermined time-domain resource; or,

when the right to use the unlicensed carrier is not obtained by contention, the UE stops sending the SRS on the first predetermined time-domain resource, continues contending for the right to use the unlicensed carrier on the unlicensed carrier, and under the condition that the unlicensed carrier is obtained by contention, sends the SRS.

When the right to use the unlicensed carrier is obtained by contention, for increasing or improving a success rate of sending the SRS, the abovementioned three manners are provided in the embodiment of the disclosure, the first predetermined time-domain resource includes a predetermined period point for sending the SRS according to a periodic opportunity or a preset sending time point for sending the SRS according to an aperiodic triggering opportunity; the second predetermined time-domain resource is configured to, when the SRS is not successfully sent on the first predetermined time-domain resource, complementally send the SRS on the second predetermined time-domain resource; and the third predetermined time-domain resource is located before or after the first predetermined time-domain resource or includes the first predetermined time-domain resource.

A complemental location for sending the SRS is located

before the first predetermined time-domain resource or after the first predetermined time-domain resource or includes the first predetermined time-domain resource.

When LBT or CCA is successfully executed on the first s OFDM symbols in the subframe or the scheduling subframe or the last k1 OFDM symbols in the previous subframe of the subframe or the scheduling subframe and the s1 OFDM symbols in the subframe or the scheduling subframe, the following conditions are included:

the PUSCH is started from a symbol s+1; or,

the PUSCH is started from a symbol s1+1, s, s1 and k1 being positive integers.

The location for sending the SRS includes one of:

the last OFDM symbol of the subframe; or,

the first OFDM symbol of the subframe; or,

the last OFDM symbol of the first half time slot in the subframe; or,

the first OFDM symbol of the second half time slot in the subframe; or,

the first OFDM symbol immediately following the moment at which the LBT or CCA detection is executed successfully; or,

a first OFDM symbol where the PUSCH is started to be transmitted.

At least one of a time-domain location for executing LBT or CCA detection, a frequency-domain location for executing LBT or CCA detection, a time-domain location for sending the SRS, a frequency-domain location for sending the SRS, a location of the time window for sending the SRS, a candidate time-domain location for sending the SRS, a candidate frequency-domain location for sending the SRS, or the transmission starting moment of the PUSCH is acquired in the following manners:

predetermining by the eNB and the UE; or,

indicating to the UE by the eNB; or,

notifying through physical-layer signaling, for example, DCI; or,

notifying through high-layer Radio Resource Control (RRC) signaling; or,

predefining.

The method further includes that: an LBT mechanism executed to send the SRS or a size of a CW of the LBT mechanism is regulated according to the number of times for which LBT is failed to be executed to send the SRS, a regulation indication includes notifying the UE for regulation by the eNB or regulation by the UE.

As illustrated in FIG. 2, an embodiment of the disclosure further provides a device for sending an SRS, which is arranged in a first communication node and includes:

a contention module, configured to contend for a right to user an unlicensed carrier according to LBT or CCA detection; and

a sending module, configured to, when contention for the right to use the unlicensed carrier is successful, send at least one of an SRS or a PUSCH on the unlicensed carrier.

When the SRS is sent on the unlicensed carrier, a location for sending the SRS includes a specific symbol in a time unit;

when the SRS is sent on the unlicensed carrier, the location for sending the SRS further includes a time window for sending the SRS;

when the SRS is sent on the unlicensed carrier, the location for sending the SRS includes at least one of: an UpPTS in a special subframe or a GP in the special subframe;

when the SRS is sent on the unlicensed carrier, the location for sending the SRS may be in a duration during which an eNB sends a reservation signal;

when the SRS is sent on the unlicensed carrier, the location for sending the SRS is in a downlink transmission period;

when the SRS is sent on the unlicensed carrier, the location for sending the SRS is in a DRS transmission period;

when the SRS is sent on the unlicensed carrier, the location for sending the SRS may include a last partial subframe after downlink transmission is ended;

when the PUSCH is sent on the unlicensed carrier, a starting location of the PUSCH includes a specific symbol on a time unit; and

when the PUSCH is sent on the unlicensed carrier, the starting location of the PUSCH further includes: a transmission moment of the PUSCH is completely determined by a moment at which the LBT or CCA is executed successfully.

Specifically,

when the SRS is sent on the unlicensed carrier, the location for sending the SRS includes the specific symbol in the time unit.

The time unit includes at least one of: a subframe or a time slot.

When the time unit is a subframe or a time slot, the specific symbol includes at least one of:

a first OFDM symbol or a last OFDM symbol.

The location for sending the SRS further includes an SRS sending time window.

The SRS sending time window is located before the time unit or after the time unit or includes the time unit.

The location for sending the SRS in the time window is determined by at least one of the following parameters:

an offset in the time window, the number of SRS durations, an interval between the SRS durations, a duration of the time window or an ending location of the SRS duration in the time window.

The SRS duration includes at least one of: a subframe, multiple subframes, a time slot or multiple time slots.

The SRS is sent on at least one symbol in the SRS duration in the SRS sending time window.

The location for sending the SRS is determined in one of the following manners:

determining by a moment at which the LBT is executed successfully;

indicating by an eNB through physical-layer DCI;

indicating the location for sending the SRS on multiple continuous subframes by the eNB through the physical-layer DCI;

indicating sending of the SRS on each subframe by the eNB; and

determining as a default that the SRS may be sent on a candidate subframe, the specific candidate subframe for sending being required to be indicated or triggered through signaling sent by the eNB.

When the SRS is sent on the unlicensed carrier, the location for sending the SRS includes at least one of:

the UpPTS in the special subframe or the GP in the special subframe.

When the SRS is sent on the unlicensed carrier, the location for sending the SRS may be in the duration during which the eNB sends the reservation signal.

The duration for the reservation signal includes a time unit from successful execution of CCA or LBT by the eNB to starting of downlink transmission.

When the SRS is sent on the unlicensed carrier, the location for sending the SRS is in the downlink transmission period.

A location of a subframe for sending the SRS in the downlink transmission period is determined in at least one of the following manners: indicating by the eNB through the physical-layer DCI; predefining; or predetermining by the eNB and UE.

When the SRS is sent on the unlicensed carrier, the location for sending the SRS is in the DRS transmission period.

Here, sending of the SRS in the DRS transmission period includes: sending on an idle symbol in a DRS subframe.

A location of the idle symbol includes at least one of:

a thirteenth symbol, a fourteenth symbol or an idle symbol location determined according to a DRS pattern.

When the SRS is sent on the unlicensed carrier, the location for sending the SRS includes the last partial subframe after downlink transmission is ended.

The location of symbol for sending the SRS on the last partial subframe after the downlink transmission is ended is indicated by the eNB through the physical-layer DCI, or determined according to the success moment of LBT or CCA or predefined.

When the PUSCH is sent on the unlicensed carrier, the starting location of the PUSCH includes the following condition:

the starting location of the PUSCH is the specific symbol on the time unit.

The time unit includes at least one of: a subframe, a time slot or a symbol.

The specific symbol includes at least one of: a symbol 0, a symbol 1, a symbol 4 or a symbol 7.

The starting location of the PUSCH further includes the following condition:

the transmission moment of the PUSCH is completely determined by the moment at which the LBT or CCA is executed successfully.

A location where the contention module executes LBT or CCA detection includes one of the following conditions:

the location of LBT or CCA detection is limited in a predetermined region; or,

the location of LBT or CCA detection is not limited.

When the location where the contention module executes LBT or CCA detection is limited in the predetermined region, the execution location of LBT or CCA detection includes one of:

last k OFDM symbols in a previous subframe of a subframe or a scheduling subframe; or,

first s OFDM symbols in the subframe or the scheduling subframe; or,

last k1 OFDM symbols in the previous subframe of the subframe or the scheduling subframe and first s1 OFDM symbols in the subframe or the scheduling subframe,

where k, s, k1 and s1 are positive integers.

The parameter k and the parameter s are both 1 or 2, and the parameter k1 and the parameter s1 are both 1.

When LBT or CCA is successfully executed on a last OFDM symbol in the previous subframe of the subframe or the scheduling subframe, the sending module is specifically configured to:

send the PUSCH and the SRS on the subframe or the scheduling subframe.

A transmission starting moment of the PUSCH in the sending module includes a first OFDM symbol in the scheduling subframe.

The location for sending the SRS in the sending module includes a last OFDM symbol in the scheduling subframe.

When the location for sending the SRS and execution location of LBT or CCA detection of next subframe in the sending module are in the same OFDM symbol, the following condition is included:

the location for sending the SRS and the execution location of LBT or CCA detection of the next subframe coexist in a frequency division manner.

A frequency-domain location for sending the SRS in the sending module includes a frequency-domain resource corresponding to a predetermined subcarrier spacing on the whole bandwidth.

The predetermined subcarrier spacing in the sending module includes: a subcarrier spacing of 1 or a subcarrier spacing of 3.

The location of LBT or CCA detection in the contention module is a location in a frequency-domain location set of the SRS.

The device further includes: a regulation module, configured to modify the location for sending the SRS.

The location for sending the SRS in the sending module includes: a first OFDM symbol in the subframe; or, a last OFDM symbol of a first half time slot in the subframe; or, a first OFDM symbol of a second half time slot in the subframe.

After the contention module successfully executes LBT or CCA on the last OFDM symbol in the previous subframe of the scheduling subframe, the sending module is further configured to:

send, by first UE or UE group, the PUSCH on the scheduling subframe and send, by second UE or UE group, the SRS on a last symbol in the scheduling subframe or a candidate subframe;

or,

the first UE or UE group, sends the PUSCH on the scheduling subframe or the candidate subframe and second UE or UE group sends the SRS on the last symbol of the subframe; or

the first UE or UE group sends the PUSCH on the scheduling subframe or the candidate subframe and sends the SRS on the last symbol of the subframe; or

the first UE or UE group sends the PUSCH on the scheduling subframe or the candidate subframe and both the second UE or UE group and the first UE or UE group send the SRS on the last symbol of the subframe.

After the contention module successfully executes LBT or CCA on the last OFDM symbol in the previous subframe of the scheduling subframe, the sending module is further configured to:

send, by the first UE or UE group, the PUSCH on the scheduling subframe and send, by the second UE or UE group, the SRS on a first symbol in the scheduling subframe or the candidate subframe;

or,

the first UE or UE group sends the PUSCH on the scheduling subframe or the candidate subframe and the second UE or UE group sends the SRS on the first symbol of the subframe; or,

the first UE or UE group sends the PUSCH on the scheduling subframe or the candidate subframe and sends the SRS on the first symbol of the subframe; or,

the first UE or UE group sends the PUSCH on the scheduling subframe or the candidate subframe and both the second UE or UE group and the first UE or UE group send the SRS on the first symbol of the subframe.

Before the operation that the second UE or UE group sends the SRS, the method further includes that: a reservation signal is sent in a blank between the moment at which the LBT or CCA is executed successfully and the location for sending the SRS.

Before the operation that the second UE or UE group sends the SRS, the method further includes that: LBT or CCA detection is executed; or, LBT or CCA detection is not executed.

An execution location of LBT or CCA detection for SRS sending of the second UE or UE group includes an OFDM symbol before the location of the SRS.

For LBT or CCA detection executed for SRS sending of the second UE or UE group, a simplified LBT mechanism or parameter configuration is executed.

An LBT or CCA operation is determined not to be executed for SRS sending of the second UE or UE group in one of the following manners:

determining to send the SRS on the candidate subframe according to an indication of the eNB; or,

determining whether to send the SRS or not according to an indication of the eNB on each subframe; or,

determining as a default to send the SRS on the candidate subframe and determining the subframe for sending the SRS according to the indication of the eNB or triggering of new signaling.

The sending module independently sends the SRS according to a 1 ms control requirement or the SRS may be independently sent regardless of the 1 ms control requirement.

After the contention module successfully executes LBT or CCA detection, if the SRS is sent according to the 1 ms control transmission requirement, the sending module sends the SRS at a predetermined time-domain location and sends the reservation signal on other time-domain resources.

The predetermined time-domain location in the sending module includes one of: the last OFDM symbol of the subframe; or, the first OFDM symbol of the subframe; or, the last OFDM symbol of the first half time slot in the subframe; or, the first OFDM symbol of the second half time slot in the subframe; or, a first OFDM symbol immediately following the moment at which the LBT or CCA detection is executed successfully.

After the contention module successfully executes LBT or CCA detection, if the SRS is sent regardless of the 1 ms control transmission requirement, the sending module sends the SRS on the first OFDM symbol immediately following the moment at which the LBT or CCA detection is executed successfully.

When the first communication node is the eNB, the operation that the sending module sends the SRS further includes one of:

the SRS is sent on an idle symbol in a DRS time-domain pattern composition;

sending the SRS in an initial signal or reservation signal sending stage; and

sending the SRS in the downlink transmission period.

The sending module is further configured to:

when the right to use the unlicensed carrier is not obtained by contention, by the UE, stop sending the SRS on a first predetermined time-domain resource, execute LBT or CCA detection before a second predetermined time-domain resource after the first predetermined time-domain resource of the unlicensed carrier, and under the condition that LBT is successfully executed before the second predetermined time-domain resource, send the SRS on the second predetermined time-domain resource; or,

when the right to use the unlicensed carrier is not obtained by contention, by the UE, stop sending the SRS on the first predetermined time-domain resource, execute LBT or CCA detection before a third predetermined time-domain resource in the time window configured to send the SRS on the unlicensed carrier, and under the condition that LBT is successfully executed before the third predetermined time-domain resource, send the SRS on the third predetermined time-domain resource; or,

when the right to use the unlicensed carrier is not obtained by contention, by the UE, stop sending the SRS on the first predetermined time-domain resource, continue contending for the right to use the unlicensed carrier on the unlicensed carrier, and under the condition that the unlicensed carrier is obtained by contention, send the SRS.

A complemental location for sending the SRS in the sending module is located before the first predetermined time-domain resource or after the first predetermined time-domain resource or includes the first predetermined time-domain resource.

When the contention module successfully executes LBT or CCA on the first s OFDM symbols in the subframe or the scheduling subframe or the last k1 OFDM symbols in the previous subframe of the subframe or the scheduling subframe and the s1 OFDM symbols in the subframe or the scheduling subframe, the sending module includes:

starting the PUSCH from a symbol s+1; or,

starting the PUSCH from a symbol s1+1, wherein s, s1 and k1 are positive integers.

The location for sending the SRS in the sending module includes one of:

the last OFDM symbol of the subframe; or,

the first OFDM symbol of the subframe; or,

the last OFDM symbol of the first half time slot in the subframe; or,

the first OFDM symbol of the second half time slot in the subframe; or,

the first OFDM symbol immediately following the moment at which the LBT or CCA detection is executed successfully. or,

at least one of a time-domain location for executing LBT or CCA detection in the contention module, a frequency-domain location for executing LBT or CCA detection in the contention module, a time-domain location for sending the SRS in the sending module, a frequency-domain location for sending the SRS in the sending module, a location of the time window for sending the SRS in the sending module, a candidate time-domain location for sending the SRS in the sending module, a candidate frequency-domain location for sending the SRS in the sending module, or the transmission starting moment of the PUSCH in the sending module may be acquired in the following manners:

predetermining by the eNB and the UE; or,

indicating to the UE by the eNB; or,

notifying through physical-layer signaling, for example, DCI; or,

notifying through high-layer radio resource control (RRC) signaling; or,

predefining.

The regulation module is configured to regulate an LBT mechanism executed to send the SRS or a size of a CW of the LBT mechanism according to the number of times for which LBT is failed to be executed to send the SRS, where a regulation indication includes notifying UE for regulation by the eNB or regulation by the UE.

### First Embodiment

In the first embodiment, at least one of a location where transmission equipment executes LBT/CCA detection, a location for sending an SRS, or transmission starting moment of a PUSCH on an unlicensed carrier is provided. In the embodiment, the transmission equipment is UE.

A first content is a content about a probable location where the UE executes LBT or CCA detection and an acquisition manner.

As illustrated in FIG. 3, for UL, the probable location where the UE executes LBT or CCA detection includes at least one of the following conditions:

LBT or CCA is always located in last k OFDM symbols in a previous subframe of a scheduling subframe;

LBT or CCA is always located in first s OFDM symbols in the scheduling subframe;

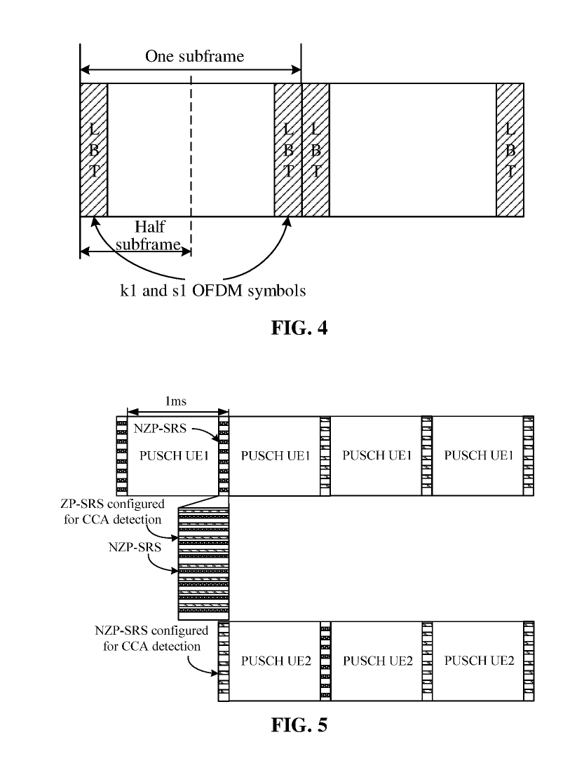

LBT or CCA is always located in last k1 OFDM symbols in the previous subframe of the scheduling subframe and s1 OFDM symbols in the scheduling subframe, as illustrated in FIG. 4; or

a location for executing LBT or CCA detection is not limited. For example, like downlink, the location for executing the LBT may be any moment.

Where, k, s, k1 and s1 are all positive integers greater than or equal to 1 and smaller than 12 or 14. In some embodiments, k and s may both be 1 or 2, and k1 and s1 are 1.

The UE may acquire the location for executing the LBT or CCA in one of the following manners:

predetermining by an eNB and the UE; or,

indicating to the UE by the eNB; or,

notifying through physical-layer signaling, for example, DCI; or,

notifying through high-layer radio resource control (RRC) signaling; or,

predefining.

A second content is a content about the location for sending the SRS and an acquisition manner.

It is specified in an existing protocol that an SRS is sent on a last OFDM symbol in a periodic SRS subframe. In combination with a characteristic of LAA that transmission equipment is required to execute an LBT mechanism before transmission on an unlicensed carrier and in combination with the location of LBT or CCA detection, the SRS may also be considered to be sent on at least one of the following locations:

a first OFDM symbol of a subframe; or,

a last OFDM symbol of the subframe; or,

a first OFDM symbol of a first half time slot in the subframe; or,

a last OFDM symbol of the first half time slot in the subframe; or,

a first OFDM symbol of the second half time slot in the subframe; or,

a last OFDM symbol of the second half time slot in the subframe; or,

a first OFDM symbol immediately following the moment at which the LBT or CCA is executed successfully; or,

an OFDM symbol in a time window for sending the SRS;

an UpPTS in a special subframe; or,

a GP in the special subframe.

Here, the subframe may be an SRS subframe or a subframe where the transmission equipment is scheduled. The location for sending the SRS in the time window for sending the SRS may be continuous in a time domain, or discontinuous in the time domain, namely discrete at the same interval or discrete at different intervals in the time domain, in the time window.

Furthermore, the location for sending the SRS in the time window may be determined by at least one of the following parameters:

a first offset in the time window, a length of continuous SRS (subframes), an interval between the SRS (subframes)/(blocks), the number of the SRS (subframes)/(blocks), a length of the time window or an ending location of a subframe or resource for sending the SRS in the time window.

The first offset in the time window refers to an interval between a starting point of the time window and a first subframe or resource configurable to send the SRS in the time window. The interval may be the number of subframes or OFDM symbols.

A location for sending the SRS in the SRS sending subframe and the location for executing the LBT may refer to contents described above regarding the location of the SRS and the location for executing the LBT or CCA detection.

The time window for sending the SRS may be located after or before or include at least one of a periodic SRS sending location, an aperiodic SRS sending location, or a preset SRS sending location.

when the time window for sending the SRS is located after or before at least one of the periodic SRS sending location, the aperiodic SRS sending location, or the preset SRS sending location, an interval between the starting point of the time window for sending the SRS and at least one of the periodic SRS sending location, the aperiodic SRS sending location or the preset SRS sending location is a second offset.

Furthermore, the location for sending the SRS or the time window for sending the SRS may be acquired in at least one of the following manners:

predetermining by the eNB and the UE; or,

indicating to the UE by the eNB; or,

notifying through the physical-layer signaling, for example, the DCI or common DCI; or,

notifying through the high-layer RRC signaling; or,

predefining.

In addition, if the SRS is sent in the special subframe, for example, the UpPTS or the GP, when the SRS is sent in the UpPTS, LBT executed to send the SRS may be in the UpPTS (for example, a first symbol in the UpPTS), or part or all of time in the GP, or part or all of time in a Downlink Pilot Time Slot (DwPTS) and the GP time, or part or all of time in last few symbols in a downlink subframe and the DwPTS and the GP time; and when the SRS is sent in the GP, LBT executed to send the SRS may be in part of the time in the GP (for example, part of first time in the GP), or part or all of time in the DwPTS and/or part of the GP time, or part or all of the time in the last few symbols in the downlink subframe and the DwPTS and/or part of the GP time.

A third content is a content about a probable transmission starting location of the PUSCH and an acquisition manner.

The probable transmission starting time of the PUSCH may be a subframe boundary, a time slot boundary and an OFDM symbol boundary,

starting transmitting the PUSCH from the subframe boundary refers to starting transmission from an OFDM symbol 0 in a subframe;

starting transmitting the PUSCH from the time slot boundary refers to starting transmission from at least one of the OFDM symbol 0 or the OFDM symbol 7 in the subframe; and

starting transmitting the PUSCH from the symbol boundary refers to starting transmission from at least one of the OFDM symbol 0, the OFDM symbol 1, the OFDM symbol 4 or the OFDM symbol 7 in the subframe.

Furthermore, the UE may acquire location information of a transmission starting moment of the PUSCH in one of the following manners:

predetermining by the eNB and the UE; or,

indicating to the UE by the eNB; or,

notifying through the physical-layer signaling, for example, the DCI and the common DCI; or,

notifying through the high-layer RRC signaling; or,

predefining.

### Second Embodiment

In the second embodiment, a method for multiplexing or simultaneous transmission of an SRS and PUSCH sent by transmission equipment on an unlicensed carrier is provided. In the embodiment, the transmission equipment is UE.

The method for multiplexing transmission of the SRS and the PUSCH (i.e., multiplexing transmission of own SRS and own PUSCH of the UE) will be introduced below mainly from three aspects.

\textcircled{1} The PUSCH is started to be transmitted from a subframe boundary.

That is, the PUSCH is always started to be transmitted from a symbol 0. Here, if a location of UL LBT or CCA detection is always in last k symbols (for example, k is 1) in a previous subframe of a scheduling subframe, the SRS may be transmitted according to the following method:

when the UE successfully executes LBT in a last symbol in the previous subframe of the scheduling subframe, its PUSCH is started to be transmitted from the subframe boundary, in such a case, the SRS may be directly sent without executing LBT, and a location for sending the SRS is a last symbol in the scheduling subframe. That is, a last symbol in the PUSCH is not used for sending the PUSCH but for sending the SRS.

In such a case, the location for sending the SRS and a location where the UE is scheduled to execute LBT or CCA of next subframe are in the same OFDM symbol (i.e., a last symbol in the subframe), and if the last symbol is occupied only by the SRS, the UE scheduled in the next subframe may not execute LBT or CCA. On the contrary, if the last symbol is occupied only by LTE or CCA, the UE may not send the SRS, and thus an eNB may not perform UL channel assessment. For solving the problem of resource collision caused by occupation of the same symbol by the SRS and LBT, the following manners may be adopted.

A first manner: the location of LBT or CCA detection and the location for sending the SRS coexist in the same symbol in a frequency division manner.

That is, a first frequency-domain resource in the last symbol in the subframe is occupied by the location of LBT or CCA detection, while a second frequency-domain resource in the last symbol in the subframe is occupied by the SRS.

where, the first frequency-domain resource and the second frequency-domain resource may be continuous in a frequency domain or may also be discrete in the frequency domain.

In addition, the first frequency-domain resource and the second frequency-domain may occupy the whole bandwidth and may also only occupy part of resources in the whole bandwidth. The other part of frequency-domain resources may be idle, or may also be used for sending a reservation signal or an occupancy signal or may further be used for sending the PUSCH.

Where, the first frequency-domain resource and the second frequency-domain resource may be of a resource element (RE) level, a physical resource block (PRB) level, a sub-band level and a resource block group (RBG) level, and are preferably RE-level resources. Furthermore, at least one of an LBT or CCA detection frequency-domain resource pattern or a reservation signal frequency-domain resource pattern may adopts an SRS frequency-domain pattern. See details in a fifth embodiment.

UEs in the same cell or the same operator share the same LBT/CCA frequency-domain pattern. Different cells of the same operator may also be configured with different LBT or CCA frequency-domain patterns. Cells with an SRS resource multiplexing requirement may adopt the same LBT or CCA frequency-domain pattern.

For example, the UE sends an SRS sequence on resources such as subcarriers indexed to be 0, 4, 8 and the like or subcarriers 2, 6, 10 and the like or 3, 7, 11 and the like in the frequency domain (it is specified in a present standard that an SRS subcarrier spacing may be 3; and however, the disclosure is not limited to the specification in the standard, and a value larger than 3 may also be adopted), and different specific sequence lengths make an occupied bandwidth and location for sending the SRS different. UEs in the same cell or the same operator share the same LBT/CCA detection pattern, and for example, LBT/CCA is executed on resources such as subcarriers indexed to be 1, 5, 9 and the like in the frequency domain. The CCA detection pattern may cross the whole bandwidth or is a pattern on part of the bandwidth, that is, different UE may execute LBT/CCA detection on specific frequency-domain resources in the whole bandwidth or execute LBT/CCA detection at locations out of a frequency-domain region corresponding to a frequency-domain resources set for sending the SRS, or under the condition that the whole frequency-domain resource on the last symbol is allocated for the SRS, frequency-domain locations where other UEs execute LBT/CCA detection may be left RBs or REs except the frequency-domain resource for the SRS on the whole bandwidth (that is, maximally 96 PRBs are occupied for the SRS on a 20 MHz bandwidth, and left RBs or REs on the whole bandwidth may be configured for the other UEs to execute LBT/CCA detection. In such a case, all or part of the left resources may be configured as common LBT/CCA detection locations or standby detection frequency-domain locations of LBT/CCA detection). In addition, the same LBT/CCA detection pattern may be configured for cells without an interference measurement requirement, and different LBT/CCA detection patterns may be configured for cells with an interference measurement requirement. The frequency-domain location where the UE sends the SRS should avoid a location of the LBT/CCA detection frequency-domain pattern. That is, the frequency-domain resource location where the UE executes LBT or CCA detection may be determined in a manner of predetermining by the eNB and the UE, or notifying the UE by the eNB, or notifying through physical-layer signaling, or notifying through high-layer signaling (RRC or media access control (MAC)) or predefining, so that a user learns that the SRS may be sent only on an SRS frequency-domain resource set, except the frequency-domain resource for LBT or CCA detection, in the frequency domain.

A second manner: the location of the SRS is modified or regulated.

In some embodiments, the location for sending the SRS may be a first symbol in the scheduling subframe. Therefore, the problem of collision between the location for sending the SRS and the location where the UE is scheduled to execute LBT or CCA detection in the next subframe may be solved well. In addition, the SRS may be sent on a first OFDM symbol in a first half time slot in the subframe, or a last OFDM symbol in the first half time slot in the subframe, or a first OFDM symbol in a second half time slot in the subframe or a last OFDM symbol in the second half time slot in the subframe.

In such a case, the UE may be triggered to send the SRS on the above symbol in one of the following manners:

indicating the UE by the eNB, or predetermining by the eNB and the UE, or predefining, or physical-layer signaling, for example, DCI or common DCI, or high-layer RRC signaling.

\textcircled{2} The PUSCH is started to be transmitted from a time slot boundary.

That is, the PUSCH is always started to be transmitted from a symbol 0 or from a symbol 7.

A first case: when the PUSCH may be started from the symbol 0, it is indicated that the UE has successfully contended for the unlicensed carrier (namely successfully executing LBT) before the subframe is started, and in such a case, the location where the UE executes LBT or CCA may be last one or more symbols of a subframe before the scheduling subframe or any location before a boundary of the scheduling subframe is started.

In such a case, transmission of the SRS may be implemented on a last symbol for the PUSCH in the scheduling subframe and LBT is not required to be executed. In such a case, if the SRS is sent on the last symbol in the scheduling subframe, a resource collision with a time-domain execution location of LBT or CCA may be brought. However, this problem may be solved by executing LBT at a location of the first frequency-domain resource and sending the SRS at a location of the second frequency-domain resource. In such a case, a first frequency-domain resource pattern for execution of LBT may adopt the SRS frequency-domain resource pattern. Here, the first frequency-domain resource and the second frequency-domain resource may adopt an RE-level resource pattern. In addition, it may also be the first OFDM symbol in the first half time slot in the scheduling subframe, or the last OFDM symbol in the first half time slot in the scheduling subframe, or the first OFDM symbol in the second half time slot in the scheduling subframe or the last OFDM symbol in the second half time slot in the scheduling subframe.

Or, LBT or CCA detection may also be independently executed for sending of the SRS, the execution location of LBT may be at least one of the last symbol in the subframe or the second last symbol in the subframe, and in this case, a time division manner is adopted for the execution location of LBT and the location for sending the SRS (That is, the UE independently executes LBT for transmission of the PUSCH and sending of its own SRS respectively). When the location for sending the SRS and the execution location of LBT or CCA for sending of the SRS are both in the last symbol, the UE starts executing LBT on the last symbol and sends the SRS (i.e., a truncated SRS) on a left time-domain resource in the symbol after a success moment of the LBT, and the location for sending the SRS in the frequency domain avoids the frequency-domain location where the UE is scheduled to execute LBT or CCA in the next subframe. When the location for sending the SRS and the execution location of LBT or CCA for sending of the SRS are both in the last one or two symbols, the UE starts executing LBT on the last symbol and sends the SRS on a first symbol (last symbol in the subframe) after the success moment, and the sending location in the frequency domain avoids the frequency-domain location where the UE is scheduled to execute LBT or CCA detection in the next subframe. The PUSCH is sent on other frequency-domain resources on the second last symbol in the subframe except for the frequency-domain resource for LBT or CCA detection. If the symbol boundary or the subframe boundary is not reached at the moment when the UE successfully executes LBT, a reservation signal is sent in a blank between the success moment of LBT and the symbol boundary or the subframe boundary, where the reservation signal may also be an SRS. In addition, puncture of part of resources in at least one of the last symbol or second last symbol in the PUSCH may be indicated to the UE by the eNB, or predetermined by the eNB and the UE, or predefined, or notified to the UE through the physical-layer signaling, for example, the DCI or the common DCI, or notified to the UE through the high-layer RRC signaling.

For example, the UE successfully completes LBT/CCA detection before the scheduling subframe, sends the PUSCH on first 12 OFDM symbols of the scheduling subframe, sends the PUSCH on an idle resource, except the frequency-domain resource for LBT or CCA, in a thirteenth OFDM symbol and sends the SRS on a resource, except the frequency-domain resource for LBT/CCA on the last OFDM symbol. In some embodiments, part of an occupancy signal, or part of the PUSCH or nothing may also be sent. Here, at least one of the LBT/CCA frequency-domain pattern or LBT/CCA frequency-domain location on the second last OFDM symbol in the subframe may be the same as or different from that on the last OFDM symbol in the subframe. LBT/CCA executed on the second last OFDM symbol may be configured for at least one of the UE which has sent a PUSCH to send its own SRS, UE which has yet not sent a PUSCH to send its own SRS, or other UE to subsequently execute an LBT/CCA operation for PUSCH transmission and/or SRS sending. LBT/CCA on the last OFDM symbol may be configured for UE sending at least one of a PUSCH or an SRS to execute the LBT/CCA operation, or for UE which has yet not completed LBT/CCA on the second last symbol to continue executing the LBT/CCA operation. Or, the whole frequency-domain resource on the second last OFDM symbol is punctured to execute LBT/CCA detection for sending of the SRS, and the SRS is sent on the last symbol. Where, the frequency division manner is adopted for the location of LBT/CCA detection and the location for sending the SRS on the last OFDM symbol.

Furthermore, in case that the UE independently executes LBT to send its own SRS, the UE may adopt a simplified LBT mechanism, for example, LBT Cat2, which refers to that, when the transmission equipment detects that a channel which is busy turns to idle and time for which the channel is kept idle is not shorter than a CCA duration, it is determined that an right to use the unlicensed carrier is acquired. Here, the CCA duration may be formed by a fixed duration+n*slot, where the fixed duration may be 16 us, n may be an integer such as 0, 1, 2, 3, 4 and 5, and slot is 9 us. Or the UE may adopt an LBT Cat4 (defer period+enhanced CCA (eCCA) process) with a small contention window (CW), where a maximum CW may be an integer such as 0, 1, 2, 3, 4, 5, 6, 7, 8 and 9. In some embodiments, a random back-off value N may be 0, 1, 2 and 3. A defer period may be formed by a fixed duration+n*slot, where the fixed duration may be 16 us or 0 us or 9 us, n may be an integer such as 0, 1, 2, 3, 4 and 5, and slot is 9 us. In addition, when it is detected in slot time in the eCCA process that the channel is busy, the defer period may also not be entered, or, the defer period is entered.

In another case: when the PUSCH may be started from a symbol 7, it is indicated that the UE fails to contend for the right to use the unlicensed carrier (namely failing to execute LBT or CCA) before the subframe is started and completes LBT and successfully contends for the right to use the unlicensed carrier before a next probable transmission starting moment (the symbol 7). In such a case, the SRS may be sent in the first symbol of the second half time slot, or the last symbol of the second half time slot, or at least one symbol in the second half time slot. The PUSCH or the reservation signal (when the reservation signal is sent, it is indicated that the PUSCH will be started to be transmitted from a boundary of the next subframe, in such a case, for sending the SRS and the PUSCH together, the UE may also send the SRS at the location of the last symbol or first symbol of the first complete subframe after LBT succeeds, and the problem of collision with the time-domain resource for LBT may also be solved in the abovementioned frequency division manner) may be sent on the other symbols, except that used for sending the SRS, on the second half time slot. In addition, the reservation signal is sent in the blank between the success moment of LBT or CCA and the boundary of the second half time slot (starting from the symbol 7), where the reservation signal may be an SRS.

\textcircled{3} The PUSCH is started to be transmitted from the symbol boundary.

That is, the PUSCH is always started to be transmitted from the symbol 0, or from a symbol 1, or from a symbol 2, or from a symbol 4 or from the symbol 7. A processing manner in case of starting from the symbol 0 or from the symbol 7 is the same as that in method \textcircled{2} above. Here, the location for executing LBT and the location for sending the SRS in case that the PUSCH is started from the symbol 1 or 4 will be described only.

When the PUSCH is started from the symbol 1 in UL, it is indicated that the location of LBT or CCA detection may be last k1 OFDM symbols in the previous subframe of the scheduling subframe and first s1 OFDM symbols in the scheduling subframe, or the location for executing the LBT is not limited (in case that the location of LBT is not limited, a starting location of the PUSCH may be undetermined, or may be the first complete symbol after the success moment of LBT, so that the SRS may be sent on a first partial or complete symbol after the success moment of LBT, or the first symbol, last symbol, last symbol in the first half time slot and first symbol in the second half time slot in a partial or complete subframe after the success moment of LBT. That is, the location for executing the LBT, the transmission starting location of the PUSCH and the location for sending the SRS may be determined by each other. In such a case, the success moment of LBT is before the symbol 1 of the subframe. In such a case, the location for sending the SRS may also be the last symbol in the scheduling subframe, where the problem of resource collision between the SRS and LBT on the last symbol may also be solved in the frequency division manner. k1 and s1 are preferably 1. Of course, the location for sending the SRS may also be the symbol 1, or the last symbol 6 in the first half time slot or the first symbol 7 in the second half subframe. Sending the SRS at the locations of the symbols 1, 6 and 7 may solve the problem of resource collision between LBT and the SRS on the same symbol.

Similarly, when the PUSCH is started from a symbol 3 in UL, it is indicated that the location of LBT or CCA detection may be the last k1 OFDM symbols of the previous subframe of the scheduling subframe or first 3 OFDM symbols in the scheduling subframe, or, the location for executing the LBT is not limited but the success moment of LBT is before the symbol 3 of the subframe. In such a case, the location for sending the SRS may also be the last symbol in the scheduling subframe, where the problem of resource collision between the SRS and LBT on the last symbol may also be solved in the frequency division manner. Of course, the location for sending the SRS may also be the symbol 3 or 4, or the last symbol 6 in the first half time slot or the first symbol 7 in the second half subframe. Sending the SRS at the locations of the symbols 3, 4, 6 and 7 may solve the problem of resource collision between LBT and the SRS on the same symbol.

In the case of an UL partial subframe, at least one of the transmission starting moment of the PUSCH, the location for executing the LBT, or the location for sending the SRS may be acquired in one of the following manners: indicating to the UE by the eNB, or predetermining by the eNB and the UE, or predefining, or the physical-layer signaling, for example, the DCI or the common DCI, or the high-layer RRC signaling.

In case that UL transmission is aligned by the symbol boundary, that is, UL of the unlicensed carrier supports transmission of the partial subframe. An UL transmission starting time point is considered from two aspects, thereby determining the location for sending the SRS.

On one aspect, the location of LBT/CCA detection is limited: here, besides the method included in the case that UL transmission is started from the subframe boundary, the following method is also included.

If the location of LBT/CCA detection is limited in the last k1 OFDM symbols in the previous subframe of the scheduling subframe and the s1 OFDM symbols in the scheduling subframe, the probable UL transmission starting time point may be an (s1+1)^{th} OFDM symbol in the subframe, and there is made such a hypothesis that k1 and s1 are both 1. When the success moment of LBT/CCA is in the k1^{th} symbol, the location for sending the SRS may be a location of a symbol s1, or the location of the last OFDM symbol of the subframe, or the last OFDM symbol (determined by the number of the s1 symbols) in the first half time slot in the subframe, or the first symbol in the second half time slot in the subframe, or the last symbol in the second half time slot in the subframe, or the first symbol in the first half time slot in the subframe, or a first partial or complete OFDM symbol after the success moment of LBT/CCA, where k1 and s2 are required not to be larger than 6 or 7. For the time-domain location for sending the SRS, if the time-domain location is overlapped with the time-domain location of LBT/CCA detection, the corresponding frequency-domain location of the SRS and frequency-domain location of LBT/CCA coexist in the frequency division manner. In addition, when the success moment of LBT/CCA is located in the limited LBT/CCA region and does not reach a boundary of the region, the SRS (i.e., the truncated SRS) may also be sent on a first partial symbol or a first complete symbol after the success moment of LBT/CCA. Furthermore, if the boundary of the region is still not reached when sending of the SRS is completed, the SRS may be repeatedly sent, or the occupancy signal or an initial signal is sent and transmission is started when a specified symbol boundary is reached.

For example, when k1 and s1 are 1, if the UE completes LBT/CCA on the last OFDM symbol of the previous subframe of the scheduling subframe, the SRS may be sent on the first OFDM symbol of the scheduling subframe. In such a case, if a boundary of the last symbol is not reached at the success moment of LBT/CCA, a blank between the success moment of LBT/CCA and the boundary of the last symbol is filled with a reservation signal, or an occupancy signal or an initial signal; or, the reservation signal or the initial signal or the occupancy signal is sent at the blank between the success moment of LBT/CCA and the UL transmission starting moment (for example, the second OFDM symbol of the subframe), and the SRS may be sent at the location of the first symbol where transmission is started, or the last symbol in the first half time slot, or the first or last symbol in the second half time slot. In such a case, for enabling the other UE to multiplex the resource occupied by the UE which has successfully executed LBT/CCA in the same cell or the same operator, the reservation signal or initial signal or occupancy signal sent by the UE which has successfully executed LBT may be sent only at a specific frequency-domain location. Here, the reservation signal or the initial signal or the occupancy signal may be an SRS, or a signal containing indication information or a demodulation reference signal (DMRS). The specific frequency-domain where the reservation signal or the initial signal or the occupancy signal is sent is required to avoid the location of the frequency-domain resource corresponding to LBT/CCA detection.

If the UE completes LBT/CCA before the boundary of the first OFDM symbol of the scheduling subframe after the last symbol of the previous subframe of the scheduling subframe, the UE may send part of the SRS (the truncated SRS) in the blank between the success moment of LBT/CCA and the transmission starting moment s1+1, or send the occupancy signal or the reservation signal in the blank between the success moment of LBT/CCA and the transmission starting moment s1+1 and send the SRS on the (s1+1)th symbol (in this example, s1 is 1, namely the SRS is sent on the second symbol of the subframe) at the transmission starting moment, or, the UE starts UL transmission from the second OFDM symbol and sends the SRS on the sixth or seventh or eighth OFDM symbol of the subframe or sends the SRS on the last OFDM symbol (twelfth or fourteenth OFDM symbol) of the subframe.

If the UE completes LBT/CCA right at the boundary of the first OFDM symbol of the scheduling subframe after the last symbol of the previous subframe of the scheduling subframe, the UE may send the SRS on the (s1+1)th symbol (in this example, s1 is 1, namely the SRS is sent on the second symbol of the subframe) at the transmission starting moment, or, the UE starts UL transmission from the second OFDM symbol and sends the SRS on the sixth or seventh or eighth OFDM symbol of the subframe or sends the SRS on the last OFDM symbol (twelfth or fourteenth OFDM symbol) of the subframe.

Similarly, when the subframe is substantially an LBT subframe, the same processing manner is adopted. If LBT/CCA is completed before the LBT subframe is ended, the SRS may be sent on a first partial or complete symbol after the success moment of LBT/CCA, or, the reservation signal is sent between the success moment of LBT/CCA and a boundary of LBT/CCA detection region and the SRS is sent on the first symbol after the LBT/CCA detection region, or the SRS is sent at the location of the last OFDM symbol of the first half time slot of the subframe, or the SRS is sent at the location of the first or last OFDM symbol of the second half time slot of the subframe. Here, the PUSCH may not be sent on the frequency domain corresponding to the time-domain location for sending the SRS, or the frequency-domain location configured for the other UE to execute LBT/CCA may also be reserved in the abovementioned manner, or the PUSCH may also be sent on a specific frequency-domain resource, and the frequency-domain location where the other UE executes LBT/CCA is also required to be reserved. If LBT/CCA is completed exactly when the LBT subframe is ended, the UL transmission starting moment is the location of the first OFDM symbol of the subframe (namely started from the symbol 0). In such a case, the SRS may be sent on the first symbol of the subframe, or the last OFDM symbol of the first half time slot of the subframe, or the first or last OFDM symbol of the second half time slot of the subframe. If LBT/CCA is not completed when the LBT subframe is ended, the UE may only wait to try for channel detection again at a next location of LBT/CCA, and if LBT/CCA is completed, the same processing manner is adopted. On the contrary, channel access at the next location of LBT/CCA is continued to be tried. Here, the location where the UE executes LBT/CCA may be determined by at least one of parameters such as a period, a starting location of CCA, a duration or an ending location of CCA. when the location of LBT/CCA and the location for sending the SRS are on the same symbol, the frequency division manner may be adopted for the frequency-domain location of LBT/CCA detection and the frequency-domain location of the SRS. Or, the time division manner may be adopted for LBT/CCA and the SRS in the time domain.

If the location of LBT/CCA detection is limited in the first s OFDM symbols in the scheduling subframe, according to different values of s, the transmission starting moment is different, s being a positive integer and s being preferably 1, 2 and 3. Therefore, a candidate transmission starting moment is a symbol indexed to be 1 (symbol indexes are started from 0), a symbol indexed to be 2, a symbol indexed to be 3 or a symbol indexed to be 7, and even may be the symbol 0 of the next subframe.

According to different candidate locations of the transmission starting moment, the location for sending the SRS may be the first symbol where transmission is started, the location of the last OFDM symbol in the first half time slot in the subframe, or the location of the first or last OFDM symbol in the second half time slot of the subframe, or the SRS may be sent on a specific symbol or any symbol between the boundary of the LBT/CCA region and the boundary of the subframe, and transmission is started from the symbol 0 of the subframe.

In addition, if the UE completes LBT/CCA before the boundary of the LBT/CCA region, the reservation signal or occupancy signal or initial signal of a partial or complete symbol is sent in the blank between the success moment of LBT/CCA and the boundary of the limited LBT/CCA region, the reservation signal or the occupancy signal or the initial signal may be an SRS or other information (useful or useless information).

If the UE does not complete LBT/CCA in the limited LBT/CCA region, the UE misses the probable transmission starting moment and may only wait to try for channel detection again at the next location of LBT/CCA. If LBT/CCA is completed, the abovementioned processing manner is adopted for the location for sending the SRS. On the contrary, channel access at the next location of LBT/CCA is continued to be tried. Or, when a present LBT/CCA process meets a specific condition, it may be determined that the UE completes the LBT/CCA process and acquires the right to use the unlicensed carrier. That is, the SRS may be sent according to the location for sending the SRS in the embodiment, and the abovementioned processing manner is adopted. The specific condition is that the present random back-off value N is not larger than a preset threshold value or it is detected by last CCA that the channel is idle. The preset threshold value may be predetermined by the eNB and the UE, or predefined, or indicated by the eNB or determined by the physical-layer signaling or the high-layer RRC signaling.

On the other aspect, the location of LBT/CCA detection is not limited. If the location of LBT/CCA detection is not limited, the UL transmission starting moment is completely determined by the success moment of LBT/CCA; or, some probable UL transmission starting moments may also be given, for example, at least one of the symbol 0, the symbol 1, the symbol 2, the symbol 4, or the symbol 7 in the subframe. Therefore, the SRS may be sent on a first partial or complete symbol after the success moment of LBT/CCA. Or, if the success moment of LBT/CCA is earlier than the probable transmission starting moment, the reservation signal or the occupancy signal or the initial signal may be sent in the blank. Here, the occupancy signal or the initial signal or the reservation signal may be an SRS. The SRS is sent on the first symbol after the transmission starting moment, or the first or last OFDM symbol in at least one of the first half time slot or the second half time slot in the subframe where the transmission starting moment is located. Or, if the success moment of LBT/CCA is right the probable transmission starting moment, the SRS may be sent on the first symbol after the transmission starting moment, or the first or last OFDM symbol in at least one of the first half time slot or the second half time slot in the subframe where the transmission starting moment is located. Or, if the success moment of LBT/CCA is later than the present transmission starting moment and earlier than the next candidate transmission starting moment, the reservation signal or the occupancy signal or the initial signal may be sent in the blank (the blank refers to a time-domain resource between the success moment of LBT and the probable transmission starting moment), where the signal may be an SRS. And/or, the SRS is sent on the first symbol after the transmission starting moment, or the first or last OFDM symbol in at least one of the first half time slot or the second half time slot in the subframe. On the contrary, if LBT/CCA is not completed before the transmission starting moment, the UE continues LBT/CCA detection until successfully contending for the unlicensed carrier, and may send the SRS according to the abovementioned methods. When the number of times for which it is detected in LBT executed to send the SRS that the channel is busy is larger than a preset value, the UE is triggered to regenerate a new value N smaller than the present random backoff value N, or, the UE is triggered to execute an operation of progressively decreasing the present value N by a certain number value (where the number value for progressive decrease is required not to be larger than the present value N), or channel detection for a CCA duration is triggered to be executed, and if it is detected that the channel is idle, it may be determined that the right to use the unlicensed carrier is acquired and UL transmission or SRS sending may be performed.

Furthermore, the above is for the SRS sending operation of the UE which successfully completes LBT/CCA detection. The other UE may perform CCA detection in the LBT/CCA detection region or on a time-frequency resource, corresponding to the time-domain location for sending the SRS, for LBT/CCA. That is, the other UE tries for channel access on a specific time/frequency-domain resource for LBT/CCA or performs signal recognition or executes LBT/CCA detection at the time-domain location of a reservation signal sending region to try for channel access, so that the UE which successfully completes LBT/CCA may send its own SRS at the probable time-domain location for sending the SRS.

How to multiplex between UEs and how to send their own SRSs in the case of a multi-subframe scheduling will be described below with an example.

There is made such a hypothesis that the location of LBT/CCA detection is the last symbol of the previous subframe of the scheduling subframe and the location for sending the SRS is the last symbol in the subframe. When UE1 completes LBT/CCA detection and 4 subframes are continuously occupied, the UE1 sends an SRS on the last symbol in the scheduling subframe. Here, for SRS sending of the UE1 on the last symbol in the scheduling subframe and a location configured for other UE to execute LBT/CCA, the problem of resource collision between SRS sending and LBT or CCA detection on the same symbol may be solved in the frequency division manner provided in the embodiment. That is, the location for sending the SRS is modified from the last symbol in the subframe to the first symbol in the subframe. Or frequency-domain resources on the last symbol includes at least one of: a shared frequency-domain resource for LBT/CCA (for example, Zero Power (ZP)-SRS frequency-domain pattern in FIG. 5), a frequency-domain resource for the SRS (for example, a Non Zero Power (NZP)-SRS frequency-domain pattern in FIG. 5), an idle resource, a PUSCH resource or a resource for a reservation signal. In some embodiments, frequency-domain resources corresponding to the last symbol is formed by a frequency-domain resource region for sending the SRS and a frequency-domain resource region for execution of LBT or CCA detection. The shared LBT/CCA frequency-domain resource on the last OFDM symbol in each of the last three subframes continuously occupied by the UE1 is idle, and the other frequency-domain resources may be used for sending the SRS of the UE1 or the reservation signal (the reservation signal may be an SRS). In some embodiments, the other resources may be used for sending the PUSCH. The purpose of sending information on the other resources is to prevent the channel from being occupied by another node. For simplicity, the UE1 sends its own SRS on the last symbol on the subsequent subframe, and then the last symbol may be formed only by the frequency-domain resource region for sending the SRS and the frequency-domain resource region for execution of LBT or CCA detection in the frequency domain. UE2 performs CCA detection on the ZP-SRS frequency-domain pattern on the last symbol of the first subframe for transmission of the UE1, and if energy detected on the corresponding ZP-SRS frequency-domain pattern is lower than a preset CCA threshold A, it is determined that the channel is idle. In some embodiments, when the energy detected by the UE in the whole frequency domain is higher than the threshold A and lower than a preset threshold B, it is determined that multiplexing is allowed. Therefore, the UE2 sends its own SRS on the corresponding SRS resource on the last symbol in the second subframe in the UL transmission subframes of the UE1 (i.e., the resource except the frequency-domain resource for LBT/CCA), and the UE2 may continuously multiplex resources of only three subframes with the UE1. Similarly, operations of the UE2 on the last symbols in the last two subframes except the subframe where the SRS is sent are the same as those of the UE1. Furthermore, the UE2, after successfully executing LBT/CCA in the last symbol in the first subframe of the UE1, may also send the SRS on the first symbol in the second subframe (it is a second subframe for the UE1 but is a first subframe for the UE2), or last symbol of the first half time slot in the second subframe, or the first or last symbol in the second half time slot in the second subframe.

### Third Embodiment

In the third embodiment, a method for multiplexing or simultaneous transmission of an SRS sent by UE and a PUSCH of other UE on an unlicensed carrier is provided.

There is made such a hypothesis that the PUSCH is started to be transmitted from a subframe boundary and a location for executing LBT or CCA detection is in last k symbols of a previous subframe of a scheduling subframe. For example, k is 1.

When UE (for example, UE1) in the scheduling subframe completes LBT at the location for executing the LBT or CCA, a PUSCH is sent on the scheduling subframe. In such a case, the UE in the scheduling subframe may be required to send an SRS or may also not have any SRS required to be sent. In such a case, another UE (for example, UE2) has an SRS sending requirement but has no PUSCH to be sent. Then, there are two processing manners.

A first manner: the UE2 executes LBT. An SRS may be sent only when LBT succeeds.

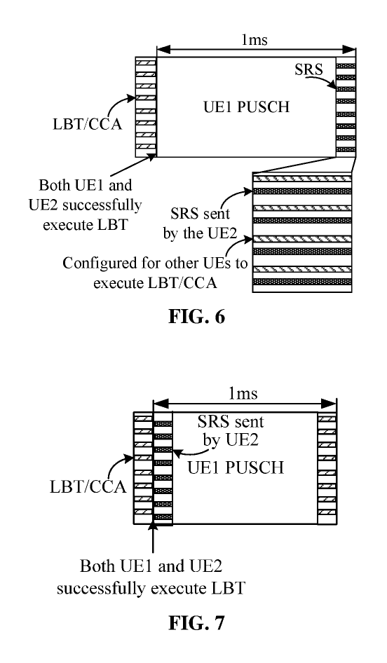

Here, a location where the UE2 executes LBT or CCA may be the location where the UE1 executes LBT or CCA, i.e., the last k symbols of the previous subframe of the scheduling subframe. If the UE2 successfully executes LBT, the UE2 may send its own SRS on the last symbol of the subframe where the UE1 sends the PUSCH. There is made such a hypothesis herein that the UE1 successfully executes LBT at the location of LBT or CCA detection, as illustrated in FIG. 6.

Or, on the basis of FIG. 6, if the UE2 successfully executes LBT and a location where the UE2 sends the SRS is the last symbol in the subframe, a blank after a success moment of LBT and before the location for sending the SRS is filled with a reservation signal (that is, the reservation signal is sent on first 11 or 13 symbols in the subframe). Here, the reservation signal may also be an SRS.

Or, the UE2 sends its own SRS on the first symbol in the subframe where the UE1 sends the PUSCH, that is, the UE2 successfully executes LBT on last k symbols of the previous subframe of the scheduling subframe and then sends the SRS on the first symbol in the scheduling subframe. The advantage is that the UE2 may send the SRS immediately after successfully executing LBT in a corresponding LBT or CCA region and is not required to consider the problem that a channel is preempted by UE of a different system or a different operator before the location for sending the SRS when the SRS is sent on the last symbol of the subframe, as illustrated in FIG. 7.

Or, the UE2 sends its own SRS on a last symbol in a first half time slot in the subframe where the UE1 sends the PUSCH. In such a case, In some embodiments, the reservation signal may also be sent in a region before the time-domain location for sending the SRS after the success moment of LBT.

Or, the UE2 sends its own SRS on a first symbol in a second half time slot in the subframe where the UE1 sends the PUSCH. In such a case, In some embodiments, the reservation signal may also be sent in the region before the time-domain location for sending the SRS after the success moment of LBT.

Or, the UE2 may send its own SRS on any subframe in subsequent subframes. The location for sending the SRS in the subframe is, for example, the first symbol, or the last symbol, or the last symbol in the first half time slot or the first symbol in the second half time slot. Or an eNB indicates whether to send the SRS or not on each subframe.

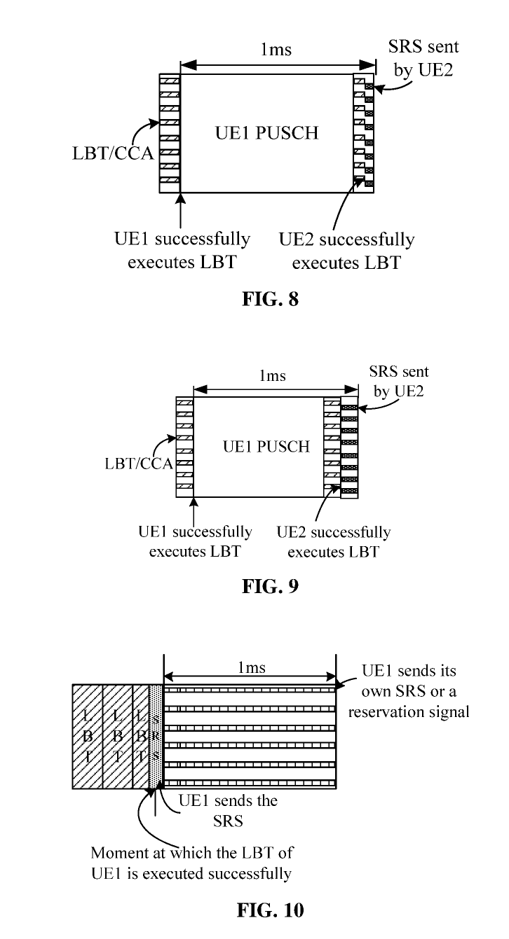

In addition, the location where the UE2 executes LBT may be at least one of the last symbol or the second last symbol in the subframe where the UE1 sends the PUSCH. If it is the last symbol, a time division manner is adopted for the location where the UE2 executes LBT and the location for sending the SRS, where a frequency division manner is adopted for a frequency-domain location for sending the SRS and a frequency-domain location where the UE is scheduled to execute LBT in a next subframe, as illustrated in FIG. 8.

If the location where the UE2 executes LBT is last two symbols or the second last symbol, a specific frequency-domain resource element (RE) for execution of LBT or CCA is only required to be idle or muted on the second last symbol, and the PUSCH is sent on other frequency-domain resources, so that UL resource waste may be reduced. The frequency-domain location for executing the LBT on the last symbol may be the same as or different from the frequency-domain location of LBT or CCA on the second last symbol. Preferably, the locations of the frequency-domain resources for execution of LBT or CCA on the last two symbols are the same. If successfully executing LBT in the second last symbol in the scheduling subframe, the UE sends its own SRS on the last symbol in the scheduling subframe. If the success moment of LBT does not reach a symbol boundary, the reservation signal may be sent, where the reservation signal may be an SRS, as illustrated in FIG. 9.

Furthermore, a subframe location or symbol location or candidate subframe location where the UE sends the SRS may be obtained in one of the following manners: it is determined as a default that the SRS may be sent on continuous or discrete subframes after LBT succeeds, or, the eNB indicates the UE that the SRS may be sent on a candidate subframe, or, the eNB indicates the UE to send the SRS on each subframe, or it is determined as a default that the SRS may be sent on the candidate subframe. However, the specific candidate subframe for sending the SRS is required to be indicated by the eNB or triggered by new signaling.

Furthermore, at least one of the time-domain or frequency-domain location where the UE executes LBT or CCA detection, or at least one of the time-domain or frequency-domain location for sending the SRS may be acquired in one of the following manners: predetermining by the eNB and the UE, or predefining, or indicating by the eNB, or physical-layer DCI or high-layer RRC signaling.

Furthermore, when the UE2 executes LBT, simplified LBT may be adopted, for example, LBT Cat2 which is only executed for a CCA duration, that is, as long as it is detected that time when the channel is idle is not shorter than the CCA duration, an right to use the unlicensed carrier may be acquired, where the CCA duration may be 16+n*slot, n may be a positive integer such as 0, 1, 2, 3, 4, 5, 6, 7 and 8, the slot is 9 us and n is preferably 0 or 1 or 2; or enhanced LBT of which a CCA detection starting point may be any location in a preset time; or, a direct eCCA process (divided into whether to enter a defer period or not when it is detected that the channel is busy, or not entering the defer period); or, LBT Cat4 with a small CW, where a maximum CW may be one of 1, 2, 3, 4, 5, 6, 7 and the like, it is also divided into whether to enter the defer period or not when it is detected that the channel is busy, or not entering the defer period, the defer period is formed by 16+n*slot, n is preferably 0 or 1 or 2 and the slot is 9 us.

A second manner: the UE2 directly sends the SRS without executing LBT.

The eNB and the UE estimate in advance or determine as a default the specific candidate subframes on which the UE can send the SRS, and in this case, the subframe where the UE can send the SRS may be occupied by UE not belonging to the local cell or UE not belonging to the same operator, thereby causing the problems that the eNB may not receive the SRS sent by the UE, the channel may not be accurately assessed or the like. Or, the eNB indicates whether the UE can send the SRS or not on each subframe, that is, the eNB may indicate the UE that the present subframe is being occupied by UE belonging to the same cell or the same operator, and then the UE may directly send the SRS on a symbol (the first symbol, or the last symbol, or the last symbol in the first half time slot, or the first symbol in the second half time slot) in the subframe without executing LBT. Or, the specific subframe for sending the SRS is determined by combining the specific candidate subframe which is estimated in advance or determined as a default by the eNB and the UE and on which the UE can send the SRS and a signaling indication of the eNB. Or, UE which has successfully occupied the channel in the same cell or the same operator notifies and interacts with other UE about occupancy information (for example, by adopting a device to device (D2D) technology) to enable the other UE to directly use a symbol in a PUSCH resource of the occupying UE to send its own SRS without executing LBT. Or, whether the channel has been successfully occupied in the same cell or the same operator or not is acquired in a blind detection manner to determine whether to send its own SRS.

The PUSCH is started to be transmitted from a time slot or symbol boundary, and a processing manner for a multiplexing transmission manner for the PUSCH of the UE1 and the SRS of the UE2 is the same as that described above.

In addition, if LBT/CCA is not completed before the transmission starting moment of the PUSCH, the UE continues LBT/CCA detection until successfully contending for the unlicensed carrier, and sends at least one of the PUSCH or the SRS. The subframe for sending the SRS is a symbol in a subframe in one or more subframes after the success moment of LBT, and the subframe or symbol for sending the SRS may be determined according to the abovementioned methods. Or, when the number of times for which it is detected in LBT executed to send the SRS that the channel is busy is larger than a preset value, the UE is triggered to regenerate a new value N smaller than a present random back-off value N, or, the UE is triggered to execute an operation of progressively decreasing the present value N by a certain number value (where the number value for progressive decrease is required not to be larger than the present value N), or channel detection for a CCA duration is triggered to be executed, and if it is detected that the channel is idle, it may be determined that the right to use the unlicensed carrier is acquired and UL transmission or SRS sending may be performed. Or, as long as it is detected by last CCA that the channel is idle, it may be determined that the right to use the unlicensed carrier is acquired and UL transmission or SRS sending may be performed even though an LBT process has yet not been completed at a transmission starting moment of the PUSCH. This manner is applied to any embodiment of the disclosure, or the condition that a success probability of channel access of the UE is increased so as to send the PUSCH, the SRS or a physical random access channel (PRACH) may be implemented.

Puncture of the specific symbol or specific frequency-domain resources in the symbols for the PUSCH, or the time-domain and/or frequency-domain location of the SRS, or a candidate time-domain and/or frequency-domain location for sending the SRS, or the specific symbol from which the PUSCH is started to be transmitted, or the time-domain and/or frequency-domain location of LBT or CCA detection, or related indication information (including indication information about that the UE may send a related message without executing LBT), which are involved in the embodiment, may be acquired in the following manners: predetermining by the eNB and the UE, or indicating to the UE by the eNB, or predefining, or notifying through physical-layer signaling, for example, DCI or common DCI, or notifying through high-layer RRC signaling.

### Fourth Embodiment

In the fourth embodiment, a method for independent sending of an SRS by UE on an unlicensed carrier is provided.

According to specificity of the unlicensed carrier, the UE is required to execute LBT/CCA at first to acquire an right to use the unlicensed carrier for transmission on the unlicensed carrier. For UL, once LBT/CCA is successfully executed, the transmission is continued for at least 1 ms. In such a case, if the UE has no data to be sent (namely having no PUSCH to be transmitted) or has a very small data size, the UE is intended to send the SRS and the SRS occupies only one OFDM symbol in a time domain, a control requirement of transmission for at least 1 ms is still required to be met.

On the basis of the above, the UE may meet the 1 ms control requirement according to one of the following manners.

A first manner: if a success moment of LBT or CCA does not reach a symbol boundary, part of the SRS (i.e., a truncated SRS) may be sent on a first partial OFDM symbol after the success moment of LBT/CCA. The UE may continuously send its own SRS within 1 ms after the success moment of LBT/CCA or send a reservation signal (a reservation signal of the whole bandwidth or part of the bandwidth may be sent) to occupy a 1 ms duration, as illustrated in FIG. 10.

For enabling other UE to multiplex a resource, the UE which successfully completes LBT/CCA may send the reservation signal or its own SRS at a specific frequency-domain location, no signal is sent at a shared LBT/CCA location under the same cell or the same operator. Here, preferably, the UE which successfully completes LBT or CCA sends its own SRS on a frequency-domain resource region for the SRS, and a reserved frequency-domain resource (the reserved frequency-domain resource and the frequency-domain resource region for the SRS fill the whole bandwidth or part of frequency-domain resources in the whole bandwidth in a frequency division manner) is used for the other UE to execute LBT or CCA detection. Specific processing manners for the case that the SRS and LBT or the reservation signal and an LBT operation are on the same symbol may adopt methods in a fifth embodiment, here, the reservation signal may be an SRS. If the other UE detects at the reserved LBT/CCA location that a channel is idle, its own SRS may be sent on a first partial or complete symbol after LBT/CCA succeeds, and a frequency-domain resource location where the other UE sends its own SRS is in the frequency-domain resource region for the SRS. By parity of reasoning, the other UE sends its own SRS in the abovementioned manner. In such a case, 1 ms is equivalent to a subframe resource for the SRS.

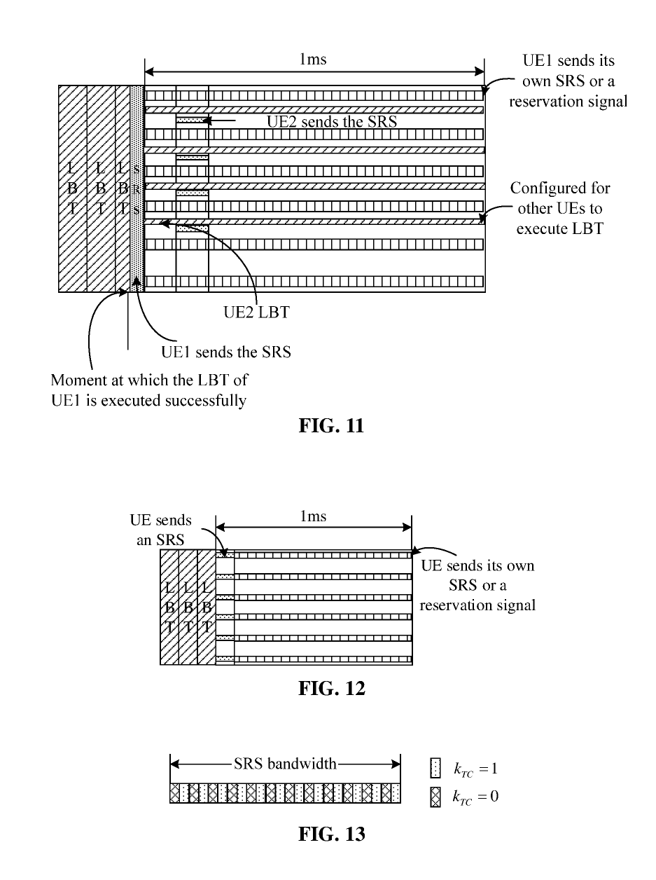

As illustrated in FIG. 11, a moment when UE1 successfully executes LBT/CCA does not reach a symbol boundary, and the UE1 sends its own SRS on a resource between the success moment of LBT/CCA and the symbol boundary. The whole frequency-domain resource is correspondingly formed by the corresponding frequency-domain resource for sending its own SRS/the frequency-domain resource corresponding to the reservation signal (the reservation signal may be an SRS) and idle resources in the frequency domain in continuous 1 ms after the symbol boundary. Here, all or part of specific resources of the idle resources are reserved for the other UE to execute LBT/CCA detection, the specific frequency-domain resource configured to execute LBT/CCA is shared by UEs within the same cell or UEs of the same operator. An LBT or CCA frequency-domain resource pattern may adopt a corresponding frequency-domain pattern of the SRS. UE2 detects at a corresponding time-frequency location of LBT/CCA that the channel is idle, and its own SRS may be sent on a first partial or complete symbol after LBT/CCA succeeds. Here, the reservation signal may be an SRS, and a time-domain length for reservation signal sending of an individual UE may last a length of at least one OFDM symbol and may maximally be a duration of 12 or 14 OFDM symbols. In addition, a frequency-domain resource location where the UE2 sends its own SRS may be a resource in a frequency-domain resource set for the SRS.

A second manner: no matter whether the success moment of LBT or CCA reaches the symbol boundary or not, the SRS is sent on a first OFDM symbol or last OFDM symbol or last symbol in a first half time slot or first symbol in a second half time slot or any symbol in continuous 1 ms after success moment of LBT/CCA. A difference between the second manner and the first manner is that, in case that the success moment of LBT/CCA does not reach the symbol boundary, a blank between the success moment and the symbol boundary is filled with a reservation signal. The own SRS or the reservation signal is sent at other time-domain locations except the time-domain location where the SRS is sent in 1 ms, the SRS or the reservation signal is in a corresponding SRS frequency-domain resource or reservation signal frequency-domain resource region, and multiplexing UE executes CCA in a region corresponding to the frequency-domain resource configured to execute LBT or CCA except the SRS frequency-domain resource or reservation signal frequency-domain resource region. When the UE sends the reservation signal on a left symbol, except the time-domain symbol for the SRS, in 1 ms, in such a case, part or all of the frequency-domain resources in the whole bandwidth in the whole 1 ms are formed by at least one of an SRS sending frequency-domain resource region or the reservation signal frequency-domain resource region and an LBT/CCA frequency-domain resource region. When the UE sends its own SRS on the left symbol, except the time-domain symbol for the SRS, in 1 ms, in such a case, part or all of the frequency-domain resources in the whole bandwidth in the whole 1 ms are formed by the SRS sending frequency-domain resource region and the LBT/CCA frequency-domain resource region.

For example, as illustrated in FIG. 12, after successfully contending for the right to use the unlicensed carrier, the UE sends the SRS immediately on a first symbol after LBT succeeds and sends the reservation signal on symbols after the SRS until the 1 ms control requirement is met. In addition, the UE may also start sending the reservation signal after the success moment of LBT and send the SRS on a preset SRS sending symbol, and the reservation signal may also be sent on the left time-domain resources of the 1 ms. Here, a location of symbol for sending the SRS may be indicated by an eNB, or predefined, or notified through high-layer RRC signaling or notified through physical-layer DCI. The location of preset symbol for sending the SRS in the 1 ms may be the first symbol, or the last symbol, or the last symbol in the first half time slot, or the first symbol in the second half time slot, or any symbol, as illustrated in FIG. 12.

In addition, the UE may also not meet the 1 ms control requirement, that is, for the case that the UE has no PUSCH but is required to send the SRS, the 1 ms control requirement is modified, and a sending manner for its SRS is as follows.

A first manner: the limit that the UE1 must continuously occupy a 1 ms duration once completing LBT/CCA may be broken and a duration of only one or more 01-DM symbols may be occupied. The UE directly sends its own SRS on a first partial or complete symbol after completing LBT/CCA. Here, in frequency-domain resources corresponding to the time domain positions for sending the SRS, besides frequency-domain resources for sending the SRS, a frequency-domain location of shared LBT/CCA detection is also required to be reserved.

In addition, for sending of the SRS, a short control signal (SCS) manner may be adopted for sending without executing LBT, as long as a ratio of a duration of the sending symbol to the total duration is within 5%. The SRS may be sent at any location or a fixed position or a SRS period point in the total duration. Here, the SRS may occupy a duration of one or more symbols, and whether the percentage requirement is met or not is determined by the total duration. For example, when the total duration is 1 ms, the sending duration of the SRS may be smaller than or equal to a length of a symbol.

In the manners provided in the embodiment, an LBT/CCA operation executed by the UE may be limited in a certain region for execution or is not limited in a certain region for execution.

In case that the location for executing the LBT is limited, if LBT or CCA is executed in a last OFDM symbol in a subframe, or a last OFDM symbol of a previous subframe of a scheduling subframe, or a last symbol of a previous subframe of an SRS sending subframe indicated by the eNB or a candidate subframe, when the UE completes LBT in the limited symbol, the SRS may be sent on the last symbol, or first symbol, or last symbol in the first half time slot or first symbol in the second half time slot on the SRS subframe or the subframe indicated by the eNB or the subframe for sending the SRS as a default or the scheduling subframe, and the reservation signal is sent on other symbols in the subframe. In such a manner, the 1 ms control requirement is met.

If LBT or CCA detection is located in a first OFDM symbol in the subframe, or a first OFDM symbol of the previous subframe of the scheduling subframe, or a first OFDM symbol of the SRS sending subframe indicated by the eNB or the candidate subframe or the last OFDM symbol of the SRS sending subframe indicated by the eNB or the candidate subframe, when the UE completes LBT in the limited symbol, the SRS may be sent on the last symbol, or last symbol in the first half time slot or first symbol in the second half time slot on the SRS subframe or the subframe indicated by the eNB or the subframe for sending the SRS as a default or the scheduling subframe, and the reservation signal is sent on other symbols, except for the symbol for executing the LTB and the symbol for sending the SRS in the subframe, that is, the 1 ms control requirement is also met. The manner may also be adopted for the other cases that the location of LBT is limited and the location of LBT is not limited.

### Fifth Embodiment

In the fifth embodiment, an LBT or CCA detection frequency-domain pattern design method and a relationship between a frequency-domain resource for sending an SRS and a frequency-domain location for executing the LBT when the SRS and LBT are on the same OFDM symbol are provided.

The frequency-domain pattern for LBT or CCA detection may be an RE-level pattern, or a PRB-level pattern, or an RBG-level pattern or a sub-band-level pattern. Preferably, the frequency-domain pattern for LBT or CCA detection adopts an RE-level pattern.

Furthermore, the frequency-domain pattern for LBT or CCA detection may adopt a ZP-channel state information (CSI) frequency-domain pattern, an SRS frequency-domain pattern or a resource pattern with a certain interval on part of or all of resources on the whole bandwidth. For example, odd/even REs or PRBs (or REs in the PRBs) or RBGs (or REs in the RBGs) or sub-bands (or REs in the sub-bands) correspondingly form the frequency-domain resource pattern for the LBT or CCA detection.

A pattern design concept will be described below with the case that the SRS frequency-domain pattern is taken as the LBT or CCA detection pattern as an example.

It is specified in a present protocol that in the frequency-domain, SRS transmission is required to cover a frequency band concerned by a frequency-domain scheduler and, when a broadband SRS is transmitted, an single SRS is sufficient to explore the whole concerned frequency band. Narrow-band SRSs of hopping frequencies in the frequency domain may also be transmitted for multiple times to implement channel quality measurement in the whole bandwidth. That is, an SRS is sent only for a relatively small frequency band at a certain moment for detection, another frequency band is to be detected at a next moment, and so on, so that channel detection for the whole system bandwidth may be implemented step by step.

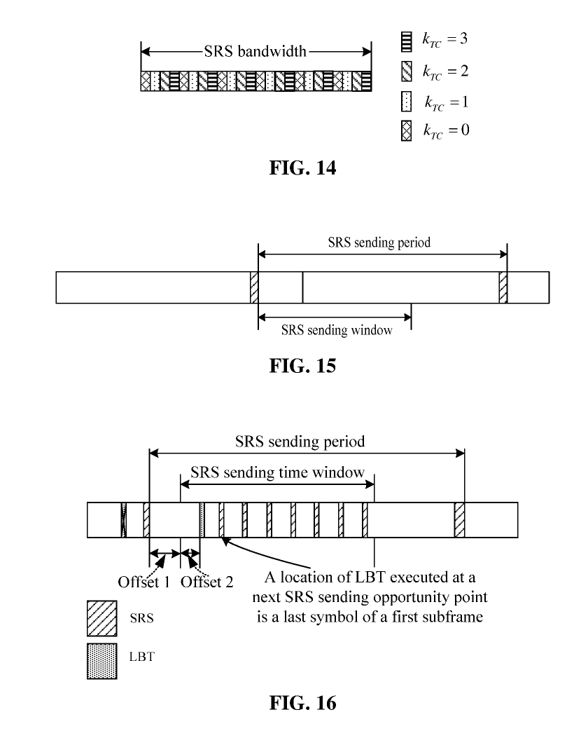

Furthermore, the SRS is sent at an interval of one or three subcarriers to form a comb frequency-domain pattern, as illustrated in FIG. 13 and FIG. 14. FIG. 13 illustrates an SRS frequency-domain pattern with a subcarrier spacing of 1 and FIG. 14 illustrates an SRS frequency-domain pattern adopting a subcarrier spacing of 3.

On the basis of the SRS frequency-domain pattern described above, there may be four different frequency-domain patterns, i.e., subcarrier frequency-domain patterns started from subcarrier indexes x, x+1, x+2 and x+3 respectively, with the subcarrier spacing of 3 and formed by all or part of the whole bandwidth. The frequency-domain pattern for LBT or CCA may adopt one frequency-domain pattern in a frequency-domain pattern set for sending the SRS. The frequency-domain pattern for the LBT or CCA may be of a cell level and may also be of a UE level.

In some embodiments, UE may acquire or determine the LBT or CCA detection pattern in one of the following manners: configuring through high-layer RRC, or, notifying through physical-layer DCI, or indicating to the UE by an eNB, or predetermining by the eNB and the UE or predefining. That is, the UE may determine the pattern for executing the LBT or CCA detection or the specific one, determined as the pattern, in an SRS frequency-domain pattern set by notifying through the signaling or indicating or predetermining.

Descriptions will be made with FIG. 14 as an example. If the frequency-domain pattern of LBT or CCA detection executed by the UE is a frequency-domain resource corresponding to k_{TC} of 0 in the SRS, the UE executes LBT or CCA on the frequency-domain resource corresponding to the k_{TC} of 0. A frequency-domain location for sending the SRS by the UE is in the left SRS frequency-domain resource set, for example, frequency-domain resources corresponding to k_{TC} of 1, 2 and 3.

Since sub-band or full-bandwidth sending is adopted for the SRS and, here, since the SRS frequency-domain pattern is adopted for LBT or CCA detection, full-bandwidth sending is preferably adopted for the SRS.

In addition, if LBT or CCA detection is executed not according to the SRS frequency-domain pattern or the whole bandwidth is allocated for the SRS, since maximally 96 PRBs are occupied for full-bandwidth sending of the SRS, for a 20 MHz bandwidth, there are 4 idle PRBs configurable for LBT/CCA detection at each of two ends of the frequency band.

### Sixth Embodiment

In the sixth embodiment, for a downlink eNB side, the embodiment provides an SRS sending method.

Sending of an SRS or an SRS sequence may specifically be implemented under one of the following conditions.

A first condition: during sending a reservation signal by an eNB, the eNB or UE sends the SRS.

For the condition that downlink transmission is started from a subframe boundary (that is, downlink transmission is started from a symbol indexed to be 0 in a subframe), if the eNB executes an LBT mechanism/CCA (for example, LBT Cat4, or defer period+eCCA (a CW may refer to an exponentially changing or fixed window), or LBT Cat3 or LBT Cat2) to successfully acquire a right to user an unlicensed carrier and a moment when LBT/CCA is successfully completed is before the subframe boundary, during this period, the eNB is required to start sending an occupancy signal/initial signal/reservation signal till the subframe boundary, Here, the occupancy signal/initial signal/reservation signal may be formed by at least one of an UL and/or downlink reference signal or channel such as a cell-specific reference signal (CRS), a primary synchronization signal (PSS)/secondary synchronization signal (SSS) and an SRS.

For the eNB side, after a moment when the unlicensed carrier is successfully preempted, the eNB is required to send the reservation signal or the initial signal to occupy a channel till a transmission moment. Here, the eNB may send the SRS at any or fixed location during sending of the reservation signal or the initial signal and may send a physical downlink control channel (PDCCH) and/or one of the following: the CRS, or the PSS/SSS, or a useless signal, or an indication signal, or the reservation signal on other symbols; or, the eNB may occupy the channel by use of the SRS or a sequence as part or all of the occupancy signal/initial signal/reservation signal. In addition, for reusing a downlink frequency, the detection eNB may identify a content of the occupancy signal/initial signal/reservation signal or perform detection on a common LBT/CCA detection pattern during sending the reservation signal, thereby judging whether the channel is available or idle. Here, a frequency-domain resource corresponding to common LBT/CCA and a frequency-domain resource corresponding to the reservation signal (the reservation signal may include at least one of: the PDCCH, the CRS, the PSS/SSS or the SRS or the like) coexist in a frequency division manner. A CCA method is that: if channel energy detected on the frequency-domain resource corresponding to the common LBT/CCA pattern is lower than a preset CCA detection threshold A (for example, −62 dBm), it is determined that the unlicensed carrier is available. And/or, furthermore, the CCA detection threshold is increased to B, whether the channel energy meets the increased CCA detection threshold B or not is detected on the whole bandwidth or the frequency-domain resource corresponding to the occupancy signal/initial signal/reservation signal, and if the channel energy is higher than the CCA detection threshold A and lower than the CCA detection threshold B, it is determined that the unlicensed carrier may be multiplexed. On the contrary, if the channel energy is higher than the CCA detection threshold B, it is determined that the unlicensed carrier does not meet a multiplexing condition and the channel is unavailable. In addition, if the detected channel energy is higher than the preset CCA detection threshold A, it is determined that the channel is unavailable. The reservation signal pattern and the common CCA detection pattern may fill the whole bandwidth in the frequency division manner and may also not fill the whole bandwidth.

For a UE side, the UE is triggered on the basis of the CRS or PDCCH sent by the eNB to send an SRS. The SRS may be sent on a first OFDM symbol after the UE detects the CRS or the indication signal or the PDCCH, or may be sent on a last OFDM symbol in the subframe or may be sent at a predefined location. In a frequency domain, the SRS may be sent on a resource except resource for the reservation signal sent by the eNB, and furthermore, is sent on a resource except a common LBT/CCA location in resources except the reservation signal resource.

For the condition that downlink transmission is started from a time slot boundary (the time slot boundary where downlink transmission may be started is 0, 3, 4 and 7), a difference with the above is that a moment when the eNB completes LBT/CCA is earlier than a first probable transmission moment, or the moment when LBT/CCA is completed is later than the first probable transmission moment and earlier than a next transmission moment, or the moment when LBT/CCA is completed is later than the next probable transmission moment and earlier than a next transmission moment of the next transmission moment or the subframe boundary or the like, and then it is necessary to send the occupancy signal/initial signal/reservation signal till a closest probable transmission moment. Similarly, the eNB side may adopt an SRS as the occupancy signal/initial signal/reservation signal. Furthermore, the SRS may only occupy all or part of a time domain and/or frequency domain of the reservation signal. The UE side may send the SRS at a specific location according to the corresponding CRS or PDCCH or PSS/SSS or indication information or the like. The specific location where the SRS is sent may be predefined, or a first symbol after corresponding triggering information is detected, or a last symbol in the subframe after the corresponding triggering information is detected, or first or last symbols in two time slots in the subframe. In addition, if the eNB and the UE share the same set of LBT/CCA detection and/or occupancy signal/initial signal/reservation signal pattern, the UE may detect whether the channel meets the condition that the channel is available or idle or not on a resource except the corresponding LBT/CCA detection pattern and/or the LBT/CCA resource or on the whole bandwidth, and a method for detecting whether the channel is available or idle or not is the same as that described above. The UE meeting the condition may send the SRS on the first OFDM symbol after LBT/CCA succeeds, the first or last symbols in the two time slots in the subframe or the predefined location. In the frequency domain, the UE may send the SRS only on the frequency-domain resource corresponding to LBT/CCA detection, or a resource except the occupancy signal/initial signal/reservation signal pattern or a resource except the LBT/CCA detection and/or occupancy signal/initial signal/reservation signal pattern.

In a special case, there is no data (physical downlink shared channel (PDSCH)) transmitted in downlink, and the eNB is required to send the occupancy signal/initial signal/reservation signal till a certain time-domain location (the certain time-domain location may be a probable UL transmission starting moment (at least one of a symbol 0, a symbol 1, a symbol 4 or a symbol 7) or an UL LBT/CCA detection starting region). Here, part or all of the occupancy signal/initial signal/reservation signal sent by the eNB may adopt an SRS sequence. For the UE side, the SRS may be sent at a specific time-domain location. Here, the specific time-domain location is the first OFDM symbol in the subframe, or a fixed or SRS sending period point in UL, or the first or last symbol in each time slot or a first partial or complete symbol after the success moment of LBT. Or, UL LBT is executed in the downlink subframe or a DwPTS, and then the SRS may be sent on a left partial or complete downlink symbol, or a partial or complete symbol in the DwPTS, or any or fixed part or one or more complete symbols in a GP or an UpPTS; or UL LBT is executed in the GP, and then SRS may be sent on any or fixed one or more symbols in the left GP and/or UpPTS. In addition, the UE may execute simple LBT/CCA detection before starting transmission and may also not execute LBT/CCA detection.

A second condition: during downlink transmission of the eNB, the eNB or UE sends the SRS.

For the condition that there is data (PDSCH) transmitted in downlink, for enabling another eNB of the same operator to multiplex when the eNB transmits the PDSCH, the eNB sending the PDSCH may reserve a specific time/frequency-domain location configured for the detection eNB to execute LBT/CCA. Here, the specific time-domain location may be predefined, or notified through high-layer RRC signaling or notified through physical-layer DCI. The time-domain resource location preferably includes last k symbols in the subframe, k being 1, 2, 3 and the like. The specific frequency domain location may be the whole bandwidth in the frequency domain, or, the whole frequency domain formed by a specific LBT/CCA frequency-domain pattern and the occupancy signal/initial signal/reservation signal pattern, or the whole frequency domain formed by the specific LBT/CCA frequency-domain pattern, the occupancy signal/initial signal/reservation signal pattern, and the PDSCH. Here, the occupancy signal/initial signal/reservation signal pattern may be an SRS (sequence) or an SRS pattern. In addition, the UE may also execute LBT at the corresponding reserved LBT/CCA time-domain location and, after the LBT is successfully executed, send its own SRS on the frequency-domain resource corresponding to LBT/CCA or the resource except the frequency-domain resource corresponding to LBT/CCA or a resource except the frequency-domain resource corresponding to LBT/CCA and the resource for the reservation signal; or send the SRS at a location of a specified symbol. The specified symbol may be the first symbol, or last symbol, or first or last symbols in the time slots in the subframe, or any symbol predefined or predetermined by the eNB and the UE in the subframe in a downlink transmission period. In the frequency domain, only the resource for sending the SRS is reserved, and the PDSCH may be sent on other resources.

For the condition that there is few downlink data (PDSCH), the eNB, after successfully completing LBT/CCA detection, sends indication information to the UE (the indication information may be an initial signal or a reservation signal), and the UE, upon reception of the indication information, may send the SRS at a location predefined or specified by the indication information, or an SRS sending period point or a first partial or complete symbol after reception of the indication information. The indication information may be at least one of a CRS, a PSS/SSS, a PDCCH, an offset (subframe index number and/or symbol index number) or the like. In addition, if data sending is completed in advance in a transmission burst at the eNB side, the occupancy signal/reservation signal may be sent; here, the occupancy signal/reservation signal may be an SRS or a sequence.

A third condition: during sending a DRS by the eNB, the eNB or UE sends the SRS.

According to a composition of the DRS and a pattern of the DRS in the time domain, it can be seen that the SRS or the SRS sequence may also be sent on an idle symbol of the DRS. Here, the composition of the DRS includes, but not limited to, at least one of: a PSS, an SSS, a CRS, a channel state information-reference signal (CSI-RS) or a position reference signal (PRS).

For the eNB side, the eNB may send the occupancy signal or the reservation signal on the idle symbol, the occupancy signal or the reservation signal may be an SRS or an SRS sequence.

For the UE, the UE may send according to location information of the DRS pattern, the SRS at a predefined location or on a first idle resource after one of the signals in the composition of the DRS is detected; or may perform detection according to the common LBT/CCA pattern and send the SRS on the first partial or complete symbol after LBT/CCA succeeds. If there is one of the signals in the composition of the DRS on the symbol after LBT/CCA succeeds, the SRS may be sent on an idle resource on the symbol. On the contrary, the SRS may be sent on any resource on the idle symbol, or the resource except resource for the occupancy signal or the reservation signal, or the resource except resource for the occupancy signal or the reservation signal and the LBT/CCA pattern. The common LBT/CCA frequency-domain resource may be part or all of the resources except at least one of the signals in the composition of the DRS. Here, frequency-domain locations or patterns of the signals in the composition of the sent DRS are different on different symbols, so that the common LBT/CCA detection pattern may be different and may also be the same on different patterns.

A fourth condition: under the condition that downlink transmission of the eNB is about to be ended, the eNB or UE sends the SRS.

For the condition of a complete subframe in downlink, the UE detects that downlink transmission is ended, or the eNB notifies the UE of an ending location of the transmission burst, the UE starts, when downlink transmission is about to be ended or after at least one idle gap duration (for example, 16 us, 25 us or 34 us), executing LBT/CCA detection and the UE which successfully executes LBT/CCA detection may send the SRS. The location for sending the SRS may be the first symbol after LBT/CCA succeeds, the last symbol in the subframe, a first or last symbol in a first half frame and a first or last symbol in a second half frame. Or, the UE directly sends the SRS on a first partial or complete symbol after the downlink burst is ended without executing LBT/CCA detection or may also send the SRS on a first partial or complete symbol after the gap, the first, last and first or last symbol in each time slot in the subframe, a symbol for periodically sending the SRS and the like. In addition, if a data sending ending moment of the eNB is earlier than an ending moment of the transmission burst, during a period between ending of transmission of the eNB and ending of the burst, the UE may directly send the SRS on a first symbol after an ending symbol of transmission or send the SRS on a first symbol after a gap duration after the ending symbol of transmission, or the UE may start executing LBT/CCA at the ending location of the eNB, and in such a case, the UE may send the SRS on the first partial or complete symbol after the success moment of LBT/CCA as long as detecting by execution for a CCA duration (for example, 25 us or 34 us) that the channel is idle.

For the condition of a downlink partial subframe, that is, the partial subframe is at the end of transmission, the eNB may notify the UE of ending location of the downlink transmission. According to information notified or indicated by the eNB, the UE may execute LBT/CCA detection at first after the ending location of the downlink transmission and before signal sending or UL transmission, and the UE which successfully executes LBT/CCA detection may send the SRS. Here, the location for sending the SRS may be as follows: the first symbol after LBT/CCA succeeds, or the last symbol in the subframe (i.e., the partial subframe), or the last symbol in the first half frame of the subframe, or the first or last OFDM symbol in the second half frame in the subframe, or a first symbol in a first complete subframe after the partial subframe, or a first or last symbol in a first half frame in the first complete subframe after the partial subframe, or a first or last symbol in a second half frame in the first complete subframe after the partial subframe, or a closest period point for sending the SRS. Or, the SRS may also be directly sent without executing LBT/CCA detection. The location for sending the SRS may be as follows: the first partial or complete symbol after the downlink partial subframe is ended, or the first symbol in the subframe, or the last symbol in the subframe, or the first or last symbol in each time slot in the subframe, or a symbol for periodically sending the SRS.

### Seventh Embodiment

In the seventh embodiment, regulation of size of a CW of an LBT mechanism executed to send an SRS, or regulation of the LBT mechanism, the LBT mechanism executed to send the SRS and a PUCCH structure design for an UL partial subframe are involved.

A first content is a mechanism or parameter configuration adopted for LBT executed to send the SRS. That is, LBT executed to send the SRS may be one of the following.

LCT Cat2: if it is detected that time when a channel is kept idle is not shorter than a CCA duration, it is determined that a right to use an unlicensed carrier is acquired. Here, the CCA duration may be a 16 us+n*slot duration, n is an integer more than or equal to 0, and n is preferably 1, 2, 3 and the like. The duration of the slot is 9 us. That is, the CCA duration may be 16 us, or, 25 us, or 34 us and the like, and may also be 9 us or 4 us.

Enhanced LBT Cat2: a difference with LBT Cat2 is that a starting point of CCA detection in the enhanced LBT Cat2 may be randomly selected within a certain period of time. This is favorable for fairness of contention between different systems for channel access. For example, if the certain time period is 10 and may be divided into 10 small segments of which each small segment occupies 1 part, transmission equipment 1 may determine a starting point of the third small segment in the ten small segments as its own CCA detection starting point, and transmission equipment 2 may fixedly configure a starting point of the seventh small segment in the ten small segments as its own CCA detection starting point. That is, different transmission equipment may randomly select their own CCA detection starting points and may also fixedly configure different starting locations for CCA detection.

A direct eCCA process: the eCCA process is formed by N slot processes and, when it is detected that the channel is busy in the slot, entering a defer period or not entering the defer period. N is a random back-off value, N is a random integer in an interval [0, p] and p is a random integer in an interval [CWmin, CWmax]. In addition, N may be indicated to UE by an eNB or predefined. Preferably, N may be 1, 2 and 3. A maximum CW CWmax may be a positive integer in an interval [1, 63]. A specific eCCA process is as follows.

In action 1, the random backoff value N is generated.

In action 2, whether N is presently larger than 0 or not is judged. If N is larger than 0, action 3 is executed. If N is equal to 0, it is determined that the right to use the unlicensed carrier is acquired. In such a case, if the UE has yet not executed slot detection or has yet not entered the eCCA process, it is necessary to reset the random back-off value N, and the action 1 is executed.

In action 3, transmission equipment detects whether the channel is idle or not in the slot, and if the channel is idle, action 4 is executed. Or, if it is detected that the channel is busy, the defer period, i.e., action 5, is entered, or, the defer period is not entered and the action 3 is directly repeated.

In action 4, an operation of progressively decreasing the value of N by a certain number value is executed. Here, the certain number value may be predefined, or indicated by the eNB or predetermined by the eNB and the UE. Preferably, N=N−1. The action 2 is executed.

In action 5, whether the channel is idle in the defer period or not is detected, and if it is assessed that the channel is idle, the action 4 is executed. If it is detected that the channel is busy, the action 5 is repeated.

A defer period+eCCA process: a difference with the direct eCCA process is that the transmission equipment is required to execute channel detection for a duration of a defer period and, if it is detected in the defer period that the channel is idle, enters the eCCA process. The defer period is formed by 16 us+n*slot, n is an integer more than or equal to 0, and n is preferably 0, 1, 2, 3 and the like. The duration of the slot is 9 us. The random back-off value N is an integer randomly selected from an interval [0, p] and p is an integer randomly selected from an interval [CWmin, CWmax]. In addition, N may be indicated to the UE by the eNB or predefined. Preferably, N may be 0, 1, 2 and 3. The maximum contention window CWmax may be a positive integer in [1, 63].

A specific eCCA process is as follows.

In action 1, whether the channel is idle or not is detected in the defer period. If it is detected that the channel is idle, action 2 is executed, or it may be determined that the right to use the unlicensed carrier is acquired and transmission is started. If it is detected that the channel is busy, the action 1 is repeated.

In action 2, the random back-off value N is generated.

In action 3, whether N is presently larger than 0 or not is judged. If N is larger than 0, action 4 is executed. If N is equal to 0, it is determined that the right to use the unlicensed carrier is acquired.

In action 4, the operation of progressively decreasing the value of N by a certain number value is executed. Here, the certain number value may be predefined, or indicated by the eNB, or predetermined by the eNB and the UE. Preferably, N=N−1.

In action 5, whether N is presently equal to 0 or not is judged, and if N is larger than 0, action 6 is executed. If N is equal to 0, it is determined that the right to use the unlicensed carrier is acquired.

In action 6, the transmission equipment detects whether the channel is idle or not in the slot, and if the channel is idle, the action 3 is executed. Or, if it is detected that the channel is busy, the defer period, i.e., the action 1, is entered, or, the defer period is not entered and the action 6 is directly repeated.

A second content is that the size of the CW of the LBT mechanism executed to send the SRS is regulated or the LBT mechanism is regulated.

The size of the LBT contention window for sending the SRS by the UE is regulated according to whether the number of times for which LBT is failed to be executed to send the SRS reaches a preset threshold value or not. For example, if the preset threshold value is 3, when the same UE continuously adopts an LBT process of which a maximum CW is 15 for channel access, the CW adopted for execution of LBT is reduced to 7 immediately after a third LBT failure. By parity of reasoning, if the UE still fails to acquire the unlicensed carrier to send the SRS when the CW is regulated to a minimum value or when an SRS sending window is ended or the preset maximum number of times for which the SRS may be sent is reached, LBT is stopped to be executed until a next SRS period point or time window. On the contrary, if the UE successfully accesses the unlicensed carrier and sends the SRS after the size of the LBT CW is regulated, an initial size of the CW is recovered. Or, the LBT execution mechanism may also be regulated according to the number of times for which LBT is failed. If LBT Cat4 (for example, the defer period+eCCA process) is adopted at the beginning and the number of times for which LBT is failed is larger than the preset value, a random backoff-free mechanism may be adopted, for example, LBT Cat2. Or, the LBT process has yet not been completed before the an SRS subframe location, and if the present value of N meets the preset threshold value or it is determined by last CCA detection that the channel is idle, it may be determined that the transmission equipment acquires the right to use the unlicensed carrier.

Here, the preset threshold value may be acquired in a manner of indicating by the eNB, or predefining or predetermining by the eNB and the UE.

A third content is the PUCCH structure design for the UL partial subframe.

In addition, in the case that the UL partial subframe, a structure of a PUCCH may be modified in a manner of frequency-domain extension and time-domain compression. For example, in case of a complete subframe, the PUCCH occupies a PRB resource at each of two ends of a frequency band, and in the case that the partial subframe, a frequency-domain extension ratio of the PUCCH is different according to different starting locations of the partial subframe. For example, in case of starting from a symbol indexed to be 7 (symbol indexes in the subframe are started from 0), the PUCCH occupies two PRBs at the two ends of the frequency domain. That is, the number of PRBs occupied by the PUCCH at the two ends of the frequency domain may be 14 divided by the number of left symbols in the subframe. For example, when the partial subframe is started from a symbol indexed to be 11, the number of PRBs occupied by the PUCCH at the two ends of the frequency domain is 14/3, that is, the number of PRBs occupied by the PUCCH at the two ends of the frequency domain is about 4 or 5 PRBs. When an SRS is to be sent on the partial subframe, the PUCCH is not sent on the symbol where the SRS is located. The SRS may also be sent on a frequency-domain resource except the frequency-domain resource occupied by the PUCCH. Or, a new time slot relationship is designed in the partial subframe, and hopping still exists for the PUCCH on each new time slot. For example, from the symbol 7 in the partial subframe, the first three symbols form a first half time slot in the partial subframe, next three symbols form a second half time slot in the partial subframe and the SRS is sent on a last symbol. A PUSCH may be sent on a resource between the frequency-domain resources for the PUCCH, or, the PUCCH directly occupies the whole bandwidth, or an occupancy signal or a reservation signal or initial information or the like is sent on the resource between the frequency-domain resources for the PUCCH.

### Eighth Embodiment

In the eighth embodiment, a method for increasing or improving an SRS sending opportunity is provided.

At first, an SRS may be sent on a specific resource. Here, the specific resource may a resource which periodically appears, or is aperiodically triggered to appear or appears periodically and aperiodically. For example, the SRS may be sent according to a preset fixed period and offset. The SRS is sent at a location of the specific resource on the premise that transmission equipment (for example, UE) must meet the condition that LBT/CCA succeeds for sending. That is, the transmission equipment (for example, the UE) may send the SRS at the location of the specific resource only after successfully contending for an unlicensed carrier before the location of the specific resource. On the contrary, if the transmission equipment fails to execute LBT or fails to contend for the unlicensed carrier before the location of the specific resource, it may not send the SRS at the location of the present specific resource. The specific resource may be acquired by one of: configuring through high-layer RRC signaling, or configuring through physical-layer DCI, or predetermining by an eNB and the UE, or indicating to the UE by the eNB or predefining.

Specifically, under the condition that the unlicensed carrier is obtained by contention, the transmission equipment (for example, the UE) normally sends the SRS on the present specific resource. Under the condition that the unlicensed carrier is not obtained by contention, the transmission equipment stops sending the SRS on the present specific resource and waits for a next specific resource. If an right to use the unlicensed carrier has yet not been obtained by contention before the next specific resource, sending of the SRS is continued to be stopped.

Or, under the condition that the unlicensed carrier is obtained by contention, the transmission equipment normally sends the SRS on the present specific resource.

Under the condition that the unlicensed carrier is not obtained by contention, the SRS is stopped to be sent on the present specific resource, and after the unlicensed carrier is obtained by contention, the SRS is complementally sent. A location where the SRS is complementally sent is not always the specific resource for sending the SRS. That is, the SRS may be sent with a delay. Such a sending manner is actually irregular sending. In some embodiments, the SRS may also be sent in advance before the specific resource. Here, the specific resource is a subframe or OFDM symbol used for sending the SRS. The SRS is usually sent on a last symbol in the subframe, may also optionally be sent on a first symbol or a last symbol in a first half time slot or a first symbol in a second half time slot in the subframe, may also be sent on a first symbol after a success moment of LBT, or a first or last symbol in a first subframe, or a last symbol in a subframe where the success moment of LBT is located or a first or last symbol in a first and/or second half time slot in the first subframe. Here, the location where the SRS is complementally sent is determined according to the success moment of LBT or is a candidate SRS resource location, i.e., a second time-domain resource in the disclosure.

Furthermore, for increasing or improving a success rate of sending the SRS or increasing the SRS sending opportunity, ensuring UL transmission timing and facilitating channel measurement of the eNB for allocation of an RB in a good transient channel state for the UE, one of the following manners may be adopted.

A first manner: an SRS sending period is shortened. It is specified in a present protocol that a sending period of UE on a licensed carrier is 2 ms, 5 ms, 10 ms, 20 ms, 40 ms, 80 ms, 160 ms and 320 ms. For an SRS sending period with a cell-level configuration, for a frequency division duplex (FDD) system, the period is 1 ms, 2 ms, 5 ms and 10 ms; and for a TDD system, the period is 5 ms and 10 ms. For an SRS sending period on an unlicensed carrier, besides cell-level and UE-level configurations, an SRS configuration period may also be shortened. For example, the shortened period is 0.5 ms and may even be configured to be shorter to make it probable to send the SRS on each OFDM symbol, for example, an SRS subframe, that is, each symbol in the subframe may be used for sending the SRS. For another example, if the SRS sending period is 0.5 ms, a probability of successfully sending the SRS once in a period of time (for example, within 10 ms) may be greatly increased. The shortened sending period may be of a UE-level and may also be configured to a cell level. Furthermore, the shortened SRS period may be configured through the high-layer RRC signaling, or configured through the physical-layer DCI, or predetermined by the eNB and the UE, or indicated to the UE by the eNB or predefined. In addition, the shortened SRS period may also be triggered according to the number of times for which LBT is failed to be executed before the configured specific SRS resource.

A second manner: an SRS sending time window is designed to increase or improve the SRS sending opportunity. The SRS sending time window may be located after or before the configured SRS resource, or the SRS sending window may include the configured SRS resource. In addition, candidate time-domain resources used for sending the SRS in the SRS sending time window may be continuous in the time domain and may also be discontinuous in the time domain. There is an offset between the first candidate SRS time-domain resource in the SRS sending time window and a starting point of the time window. In some embodiments, the offset may be 0.

The SRS sending time window may also periodically appear, that is, one or more SRS sending time windows may exist in each SRS sending period. When failing to contend for the unlicensed carrier resource on an SRS period time point, the transmission equipment may sequentially try to contend for the unlicensed carrier before candidate SRS resource locations in the SRS sending time window after the SRS period time point before a next SRS period time point. When successfully contending for the unlicensed carrier before the candidate SRS resource location in the time window, the transmission equipment sends the SRS at the first candidate SRS resource location after the success moment of LBT. In such a case, the transmission equipment is required to wait for a next sending opportunity of sending the SRS, i.e., the next SRS period time point. When the unlicensed carrier is not obtained by contention before the candidate SRS resource location in the SRS sending time window, that is, the SRS is failed to be sent in the SRS sending window, the next sending opportunity, i.e., a next preset SRS period time point, is required to be waited for. Here, the SRS period point or the candidate SRS resource in the time window may be considered as a subframe location for sending the SRS, but the specific time-domain location for sending the SRS is preferably the last symbol of the subframe and is optionally the first symbol in the subframe. An execution location of LBT/CCA is preferably at last one or two symbols in a previous subframe of the SRS period point or the candidate SRS resource location in the time window. In some embodiments, the location of LBT/CCA may also be the first symbol of the subframe or the first and last symbols in the subframe. Here, the period point mentioned herein is the specific resource in the embodiment or a first time-domain resource in the disclosure. The resource used for sending the SRS in the SRS sending time window is a third time-domain resource in the disclosure.

A third manner double periods are set to increase or improve the SRS sending opportunity. For example, besides a preset long period, a short period is set to try to complementally send the SRS. When the SRS is failed to be sent on a period point of the preset long period, sending of the SRS may be continued to be tried on a period point of the subsequent short period. When the SRS is successfully sent on the period point of the preset long period, the next SRS sending opportunity is a period point of a next preset long period, that is, sending is not required to be tried on the period point of the subsequent short period.

Descriptions will be made to the three abovementioned SRS sending manners with examples.

If the SRS sending period T_{SRS} is configured to be 20 ms, an SRS configuration index Isrs is 30 and an offset T_{offset} is 5 ms, the subframe for sending the periodic SRS must meet (10·n_{f}+k_{SRS}−T_{offset})mod T_{SRS}=0 that is, a subframe #5 in a second frame in the 20 ms period is the subframe for sending the SRS. Then, a probable SRS sending time point is the subframe 5 (i.e., the subframe index number is 5), a subframe 25 (i.e., a subframe 5 in a first frame in a next 20 ms period), a subframe 45 and the like. Here, the SRS is only sent on a last OFDM symbol in the above subframe, that is, the SRS lasts for a length of an OFDM symbol (about 71 us) in the time domain (that is, there is only one SRS sending opportunity in a period).

Whether the SRS may be sent on the period point or not is completely determined by an LBT/CCA detection result of the UE on the unlicensed carrier. For example, when the UE successfully contends for the unlicensed carrier before the subframe 5, the SRS is sent on the subframe 5. When the UE fails to contend for the unlicensed carrier before the subframe 5, the SRS is stopped to be sent on the subframe 5. Contention for the right to use the unlicensed carrier is continued to be tried on a next period point (for example, the subframe 25), and if LBT is also failed to be executed, the UE may not send the SRS on the subframe 25 and may send the SRS only when successfully contending for a resource of the subframe 45 in the next opportunity. The SRS is usually sent on the last symbol in the subframe. That is, when LBT is successfully executed before any subframe of the subframe 5, or the subframe 25, or the subframe 45 or the like, the SRS is sent on a first period point after LBT succeeds. Furthermore, the SRS may be sent on at least one of the first symbol on the period point, the last symbol on the period point, first and/or last symbol(s) of the first half time slot on the period point, or first and/or last symbol(s) of the second half time slot on the period point (for example, the period point is a subframe location). The execution location of LBT is preferably last k symbols of the previous subframe of the subframe where the SRS is sent, k may be 1 and 2. Or, the location of CCA detection may also not be limited, as long as LBT is successfully executed before the configured SRS sending location. When the success moment of LBT is earlier than the location for sending the SRS, a reservation signal or an initial signal or an occupancy signal is sent in a blank between the success moment of LBT and the SRS sending subframe. Here, the reservation signal or the initial signal or the occupancy signal may be sent on part of resources in the whole bandwidth, and the part of the resources may be formed by RBs or REs or RBGs or sub-band-level resources at the same interval and/or different intervals in the whole bandwidth.

For the first manner, a shorter SRS sending period may be designed. For example, the SRS sending period may be 10 ms, 5 ms, 2 ms, 1 ms or 0.5 ms, and the SRS may even be sent on each 01-DM symbol in the subframe.

For the second manner, for increasing or improving the success rate of sending the SRS, the SRS sending time window is designed. FIG. 15 is a schematic diagram of an SRS sending time window located after a present SRS period point and before a next SRS period point.

Descriptions will be made herein with the 20 ms period as an example. When the UE successfully contends for the right to use the unlicensed carrier on the subframe 5, the SRS is sent on the subframe 5, and the next SRS sending opportunity is the subframe 25 (here, the subframe 25 refers to a subframe of which a subframe index number is 5 in the first frame in the next period, and there is made such a hypothesis that subframes in each radio frame are sequentially arranged). When the UE fails to contend for the unlicensed carrier on the subframe 5, LBT/CCA detection is continued to be executed before the candidate SRS resource location in the time window after the subframe 5 and the UE tries to send the SRS. Here, a length of the time window may be preset, or predetermined by the eNB and the UE, or notified through the physical-layer DCI or notified through high-layer RRC. Furthermore, the starting point of the time window and the SRS period point may be continuous and may also be discontinuous in the time domain. The discontinuous starting point of the SRS sending time window may be determined by the offset between the SRS period point and the starting point of the time window. Furthermore, the candidate locations where the UE sends the SRS in the time window may be continuous and may also be discrete. The location for sending the SRS in the time window may be determined by one of the following parameters: an offset in the time window, the number of SRS sending durations or an interval between the SRS sending durations. The SRS sending duration is a length of one or more subframes, the SRS only occupies a length of an OFDM symbol in the subframe of the SRS sending duration. As long as successfully executing LBT/CCA before a preset candidate SRS sending location in the time window, the UE may send the SRS at the candidate resource location. A specific schematic diagram of the SRS sending time window is illustrated in FIG. 16, i.e., a schematic diagram of multiple continuous SRS sending opportunity points in the SRS sending time window.

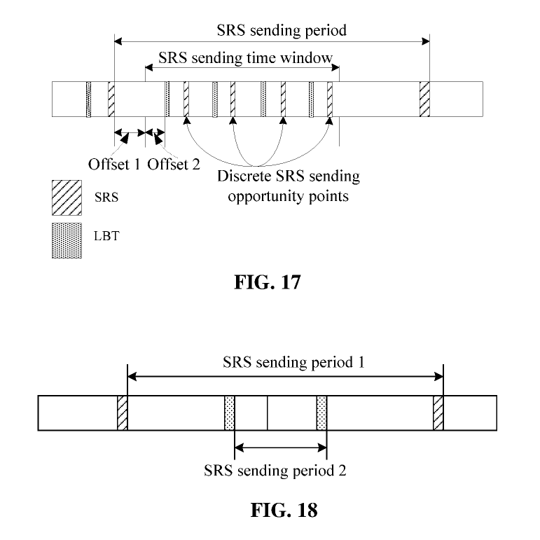

That is, when failing to execute LBT on the period point, the UE may try to contend for accessing the unlicensed carrier on multiple continuous SRS sending opportunity points in configured time and, when successfully executing LBT before any opportunity point in the multiple continuous SRS opportunity points, may send the SRS on the SRS opportunity point. In FIG. 16, the time-domain location for sending the SRS in the time window is the last OFDM symbol on the SRS opportunity point (in the subframe) and the location of LBT executed to send the SRS is the last k symbols in the previous subframes. Here, k is preferably 1 or 2. Furthermore, there may be its own PUSCH, a PUSCH of other UE and an idle resource in the blank between the location of LBT and the location for sending the SRS. FIG. 17 is a schematic diagram of an SRS sending time window with multiple discrete SRS sending opportunity points, an offset 1 in FIG. 17 may preferably be configured to be 0, and an offset 2 may also be configured to be 0.

Furthermore, each OFDM symbol location in the time window may also be configured for sending the SRS, the location of LBT executed to send the SRS is in one or more symbols before the SRS, and the first symbol after the success moment of LBT may also be taken as the location for sending the SRS.

For the third manner, a manner of combining a short period and a long period to send the SRS may be designed, as illustrated in FIG. 18.

For example, the long period is 20 ms, and the short period is 5 ms. When the UE successfully contends for the unlicensed carrier resource before a subframe (for example, the subframe 5) corresponding to the starting point of the long period, the SRS is sent on the SRS period point in the long period. The next SRS sending opportunity is an SRS period point in a next long period, for example, the subframe 25. When fails to contend for the SRS sending opportunity point in the long period, the UE may try to contend for the unlicensed carrier on the SRS opportunity point (for example, a subframe 10, a subframe 15 and a subframe 20) in the short period (for example, a 5 ms period) and, if contending for the right to use the unlicensed carrier on the subframe 10, sends the SRS on the subframe 10, and the next SRS sending opportunity is the period point corresponding to the long period, for example, the subframe 25. When the unlicensed carrier is not obtained by contention, contention for the unlicensed carrier may be tried sequentially before the subsequent subframe 15 and subsequent 20, thereby sending the SRS.

Here, the SRS may also be triggered by aperiodic DCI to be sent. However, no matter whether the SRS is sent periodically, aperiodically or periodically and aperiodically, the UE may send it only after successfully executing LBT/CCA. In a special case, the UE may directly send the SRS at an SRS triggering or periodic or preset location without considering LBT/CCA, that is, a short control signaling (SCS) manner is adopted for sending the SRS.

In addition, for an aperiodically triggered SRS manner, when LBT is failed to be executed before the location for sending the SRS, the method in the embodiment may be adopted. For example, an SRS sending time window is complemented after the aperiodically triggered SRS resource location, or, the SRS is tried to be sent at the resource location for periodically sending the SRS. Whether the SRS may be sent at probable SRS sending resource locations or not is determined by results of LBT/CCA executed before these probable SRS resource locations. When LBT/CCA is successfully executed, the SRS is sent at the first probable SRS resource location after LBT succeeds. Or, when LBT is failed to be executed before the aperiodically triggered SRS resource, the transmission equipment may continue executing LBT detection until successfully contending for the right to use the unlicensed carrier by LBT and then immediately send the SRS. In such a case, the location for sending the SRS is preferably located on a first partial or complete symbol after the access moment of LBT, or a first or last symbol in the first time slot, or a first symbol or last symbol in a first subframe, or the last symbol in the subframe where the success moment of LBT is located or a first or last symbol on a first and/or half time slot(s) in the first subframe. Or, when LBT is failed to be executed before the periodic SRS location, contention for the unlicensed carrier is tried again before the SRS sending location determined by aperiodic triggering, and when the unlicensed carrier is obtained by contention, the SRS is sent at the aperiodically triggered SRS location. On the contrary, when LBT is failed to be executed, execution of LBT may be continued to be tried before the candidate SRS resource. Here, the candidate SRS resource may be a resource corresponding to the shortened SRS period, and/or an SRS resource corresponding to the double periods or a resource configured for transmitting the SRS in the SRS sending time window.

Furthermore, the location for sending the SRS may be determined according to the success moment of LBT or CCA or the location of LBT or CCA.

### Ninth Embodiment

In the ninth embodiment, a method for determining a location for sending an SRS according to a success location of LBT is provided. According to the method, determination of the location for sending the SRS on the basis of a success moment of LBT is provided on the basis of an uncertainty about sending of the SRS on an unlicensed carrier.

Specifically, a location of LBT/CCA detection executed to send at least one of the SRS or a PUSCH may be one of: last k OFDM symbols in a previous subframe of a scheduling subframe, or first s OFDM symbols in the scheduling subframe, or last k1 OFDM symbols in the previous subframe of the scheduling subframe and s1 OFDM symbols in the scheduling subframe, or k4 symbols before a symbol where the SRS is sent, or adopts a time division manner when being in the same symbol with the SRS. In some embodiments, k, s and k4 are 1 or 2, and k1 and s1 are 1.

When the location of LBT/CCA detection is the last k symbols of the previous subframe of the subframe where the SRS is sent or the scheduling subframe, if the success moment of LBT/CCA does not reach a starting point of the subframe where the SRS is sent or the scheduling subframe, a partial and/or complete reservation signal or initial signal or occupancy signal may be sent in a blank between the success moment of LBT/CCA and the starting point of the subframe where the SRS is sent or the scheduling subframe, the PUSCH is sent on the subframe where the SRS is sent or the scheduling subframe, and on the last symbol of the subframe, the PUSCH is not sent and the SRS is sent. Here, a frequency-domain location for sending the SRS should avoid a shared frequency-domain resource location of LBT/CCA detection. That is, the frequency-domain location for sending the SRS and the shared frequency-domain location of CCA detection coexist in a frequency division manner. Furthermore, the reservation signal or the initial signal or the occupancy signal may be sent on the whole bandwidth or sent only on a specific RE or PRB or RBG or sub-band in the frequency domain, and on part or all of resources in left frequency-domain resources in the whole bandwidth, no signal is sent and these resources are used for other UEs (UE in the same cell or UE of the same operator) to execute LBT/CCA detection. Here, the reservation signal may be an SRS. When the success moment of LBT/CCA is right the starting point of the subframe where the SRS is sent, the PUSCH is sent on the subframe where the SRS is sent, and on the last symbol of the subframe, the PUSCH is not sent and the SRS is sent. Furthermore, the PUSCH may not be sent on an idle partial RE on the second last or third last symbol in the subframe, and the idle partial RE is configured for the UE or the other UE to send its own SRS signal on the last symbol. When the UE fails to execute LBT at the location of LBT/CCA detection, the SRS may not be sent on the present SRS subframe. Or, when the UE fails to execute LBT at the location of LBT/CCA detection and successfully executes LBT on the idle partial RE on the second last symbol or the third last symbol in the SRS subframe, that is, it is detected that a channel is idle, its own SRS may be sent on the last symbol in the SRS subframe. Since the UE does not complete an LBT process at the corresponding location of LBT/CCA detection, simplified LBT, for example, LBT Cat2, or LBTCat4 with a relatively small CW (for example, CWmax is 3), or a direct eCCA process or a similar LBT process for DRS sending (as long as it is detected that time when the channel is kept idle is not shorter than a preset CCA duration, for example, 25 us or 34 us) may be executed on the idle partial RE on the last second or third symbol in the SRS subframe. Here, besides the last symbol in the SRS subframe, the SRS may be sent on at least one of the first symbol in the subframe, the first symbol in the first half time slot, the last symbol in the first half time slot, the first symbol in the second half time slot, or the last symbol in the second half time slot; or, the SRS may be sent on any one or more symbols in the subframe. The PUSCH may not be sent at the corresponding location for sending the SRS in the subframe. Correspondingly, if the UE independently executes LBT for sending of the PUSCH and the SRS, the location for sending the SRS may be the first or multiple symbols before the location for sending the SRS in the subframe. The specific location for sending the SRS may be determined to be one or more in candidate symbol locations according to a value of k.

When the location of LBT/CCA detection is in the last k1 OFDM symbols in the previous subframe of the subframe where the SRS is sent or the scheduling subframe and the s1 OFDM symbols in the scheduling subframe, the location for sending the SRS may be at least one of the first symbol after the s1 symbols, the last symbol in the time slot where the s1 symbols are located, the first symbol of the time slot after the time slot where the s1 symbols are located, the last symbol of the time slot after the time slot where the s1 symbols are located. When the success moment of LBT/CCA does not reach a boundary of an LBT/CCA detection region, a reservation signal or an initial signal or an occupancy signal is sent, and a sending manner for the reservation signal and an independent LBT execution manner and location for the SRS are similar to the processing method for the abovementioned condition. The specific location for sending the SRS may be determined to be one or more in the candidate symbol locations according to values of at least one of k1 or s1.

When the location of LBT/CCA detection is in the first s OFDM symbols in the subframe where the SRS is sent or the scheduling subframe, under this condition, if the success moment of LBT/CCA does not reach a boundary of the first s symbols, the reservation signal or the initial signal or the occupancy signal is sent in the blank between the success moment of LBT/CCA and the boundary of the first s symbols. Here, processing for the reservation signal is the same as the abovementioned condition. When the success moment of LBT/CCA exactly reaches the boundary of the first s symbols, the SRS may be sent on at least one of the first symbol after the s symbols, the last symbol in the time slot where the s symbols are located, the first symbol of the time slot after the time slot where the s symbols are located, the last symbol of the time slot after the time slot where the s symbols are located. The specific location for sending the SRS may be determined to be one or more in the candidate symbol locations according to a value of s.

When the location of LBT/CCA detection is k4 symbols before the symbol where the SRS is sent, preferably, if the success moment of LBT/CCA exactly reaches a boundary of the first k4 symbols, the SRS may be normally sent at the location for sending the SRS. When the success moment of LBT/CCA does not reach the boundary of the first k4 symbols, it is necessary to send the reservation signal, and other processing manners are the same as the methods described in the abovementioned conditions. The specific location for sending the SRS may be determined to be one or more in the candidate symbol locations according to a value of k4.

When the time division manner is adopted for locations of LBT/CCA detection and the SRS in the same symbol, if the success moment of LBT/CCA does not reach the boundary of the symbol, part of the SRS (i.e., a truncated SRS signal) may be sent on the left resources of the symbol. Here, the same symbol may be the symbol at the location of LBT/CCA or the symbol where the SRS is sent. When the success moment of LBT/CCA exactly reaches the boundary of the symbol, the SRS is preferably sent on at least one of a first symbol after the success moment of LBT/CCA, the last symbol in the subframe where the success moment of LBT/CCA is located, the first symbol in the subframe where the success moment of LBT/CCA is located or the next subframe, the last symbol in the subframe where the success moment of LBT/CCA is located or the next subframe, the first symbol in the first half time slot in the subframe where the success moment of LBT/CCA is located or the next subframe, the last symbol in the first half time slot in the subframe where the success moment of LBT/CCA is located or the next subframe, the first symbol in the second half time slot in the subframe where the success moment of LBT/CCA is located or the next subframe, or the last symbol in the second half time slot in the subframe where the success moment of LBT/CCA is located or the next subframe.

In addition, the location of LBT/CCA executed to send the SRS is not limited, and the location for sending the SRS is completely determined by the success moment of LBT/CCA. That is, the UE sends the SRS on at least one of the first partial or complete symbol after the success moment of LBT/CCA, the last symbol in the subframe where the success moment of LBT/CCA is located, and/or the first symbol and/or last symbol in the subframe where the success moment of LBT/CCA is located, and/or the first symbol and/or last symbol in the subframe where the success moment of LBT/CCA is located or the next subframe and/or the first and/or last symbol(s) in the first half time slot and/or the second half time slot. In such a case, the sending location of the SRS may not be the configured periodic SRS location or the candidate SRS sending location provided in the embodiment, for example, the candidate SRS resource location in the SRS sending time window, or the SRS location of the shortened period or the SRS location corresponding to the double periods.

Obviously, those skilled in the art should know that each module or each operation of the disclosure may be implemented by a universal computing device, and the modules or operations may be concentrated on a single computing device or distributed on a network formed by a plurality of computing devices, and may In some embodiments be implemented by program codes executable for the computing devices, so that the modules or operations may be stored in a storage device for execution with the computing devices, the illustrated or described operations may be executed in sequences different from those described here in some circumstances, or may form each integrated circuit module respectively, or each of multiple modules or operations therein may form a single integrated circuit module for implementation. As a consequence, the disclosure is not limited to any specific hardware and software combination.

The above is only the preferred embodiment of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

### INDUSTRIAL APPLICABILITY

The method and device for sending an SRS disclosed in the embodiments of the disclosure relate to the field of wireless communication. The method includes that: a right to use an unlicensed carrier is contended for according to LBT or CCA detection; and when the contention for the right to use the unlicensed carrier is successful, the SRS is sent on the unlicensed carrier. SRS sending methods for the conditions of simultaneous or unsimultaneous transmission of an SRS and a PUSCH and an UL partial subframe are provided, and more SRS sending opportunities are also provided. For downlink transmission, an SRS sequence is adopted as an occupancy signal, thereby simplifying design of the occupancy signal.

1. A method for sending a sounding reference signal (SRS), applied to a first communication node, the method comprising:
contending for a right to use an unlicensed carrier according to a listen before talk (LBT) or a clear channel assessment (CCA) detection; and
when the contention for the right to use the unlicensed carrier is successful, sending at least one of an SRS or a physical uplink shared channel (PUSCH) on the unlicensed carrier.

2. The method according to claim 1, wherein when the SRS is sent on the unlicensed carrier, a location for sending the SRS comprises a specific symbol in a time unit,
wherein the time unit comprises at least one of: a subframe or a time slot; or
wherein the specific symbol comprises at least one of: a first orthogonal frequency division multiplexing (OFDM) symbol, a last OFDM symbol, a first OFDM symbol after the contention for the right to use the unlicensed carrier is successful, or at least one symbol in a second half time slot.

3. (canceled)

4. (canceled)

5. The method according to claim 2, wherein a location for sending the SRS comprises a time window for sending the SRS,
wherein the time window for sending the SRS being located before the time unit or after the time unit or comprising the time unit; or
wherein the location for sending the SRS in the time window is determined by at least one of the following parameters:
an offset in the time window, time length of SRS transmission, a number of SRS durations, an interval between the SRS durations, a duration of the time window or an ending location of the SRS sending duration in the time window,
wherein the SRS duration comprises at least one of: a subframe, a plurality of subframes, a time slot, or a plurality of time slots; or
wherein the SRS is sent on at least one symbol in the SRS duration in the time window for sending SRS.

6.-9. (canceled)

10. The method according to claim 2, wherein determining the location for sending the SRS comprises one of the following:
determining the location for sending the SRS according to a moment at which the LBT is executed successfully;
determining as a default that the SRS can be sent on continuous or discrete subframes or time slots after the LBT succeeds;
indicating the location for sending the SRS by an eNodeB (eNB) through physical-layer downlink control information (DCI);
indicating the location for sending the SRS on multiple continuous subframes or time slots by the eNB through the physical-layer DCI;
indicating the location for sending the SRS on each subframe or time slot by the eNB;
indicating, by the eNB, the UE to send the SRS on a candidate subframe or time slot; or
determining as a default that the SRS can be sent on a candidate subframe or time slot, a specific candidate subframe or time slot for sending the SRS being required to be indicated or triggered through signaling sent by the eNB.

11. The method according to claim 1, wherein when the SRS is sent on the unlicensed carrier, a location for sending the SRS comprises at least one of:
an uplink pilot time slot (UpPTS) in a special subframe or a guard period (GP) in the special subframe; or
when the SRS is sent on the unlicensed carrier, the location for sending the SRS is in a duration during which the eNB sends a reservation signal; or
when the SRS is sent on the unlicensed carrier, the location for sending the SRS is in a downlink transmission period; or
when the SRS is sent on the unlicensed carrier, the location for sending the SRS is in a discovery reference signal (DRS) transmission period; or
when the SRS is sent on the unlicensed carrier, the location for sending the SRS comprises a last partial subframe or time slot after downlink transmission is ended;
or, wherein when the first communication node is an eNB, sending the SRS further comprises one of:
sending the SRS on an idle symbol in a DRS time-domain pattern composition;
sending the SRS in an initial signal or reservation signal sending stage; or
sending the SRS in a downlink transmission period.

12. (canceled)

13. The method according to claim 11, wherein the duration for sending the reservation signal comprises a time period from successful execution of CCA or the LBT by the eNB to starting of downlink transmission; or
wherein a location of a subframe or time slot for sending the SRS in the downlink transmission period comprises at least one of the following:
indicating the location of the subframe or time slot for sending the SRS by the eNB through a physical-layer DCI;
predefining the location of the subframe or time slot for sending the SRS; or
predetermining the location of the subframe or time slot for sending the SRS by the eNB and a terminal; or
wherein sending the SRS in the DRS transmission period comprises: sending the SRS on an idle symbol in a subframe for sending DRS; wherein the idle symbol comprises at least one of: a thirteenth symbol, a fourteenth symbol or an idle symbol determined according to a DRS pattern; or
wherein determining a location of a symbol for sending the SRS on the last partial subframe or time slot after the downlink transmission is ended comprises one of the following:
indicating the location of the symbol for sending the SRS by the eNB through a physical-layer DCI;
determining the location of the symbol for sending the SRS according to a moment at which the LBT or CCA is executed successfully; or
predefining the location of the symbol for sending the SRS.

14.-20. (canceled)

21. The method according to claim 1, wherein when the PUSCH is sent on the unlicensed carrier, a starting location of the PUSCH comprises a specific symbol in a time unit,
wherein the time unit comprises at least one of: a subframe, a time slot or a symbol; or
wherein the specific symbol comprises at least one of: a symbol 0, a symbol 1, a symbol 4 or a symbol 7; or
wherein a transmission moment of the PUSCH is completely determined by the moment at which the LBT or CCA is executed successfully.

22.-25. (canceled)

26. The method according to claim 21, wherein a location for executing the LBT or CCA detection comprises one of the following:
last k OFDM symbols in a previous subframe of a subframe or a scheduling subframe or in a previous time slot of a time slot;
first s OFDM symbols in the subframe or the scheduling subframe or the time slot;
last k1 OFDM symbols in the previous subframe of the subframe or the scheduling subframe and first s1 OFDM symbols in the subframe or the scheduling subframe; or
last k1 OFDM symbols in the previous time slot of the time slot and first s1 OFDM symbols in the time slot,
wherein k, s, k1 or s1 is a positive integer and the k or the s is 1 or 2, or the k1 or the s1 is 1.

27. (canceled)

28. The method according to claim 26, further comprising:
when the LBT or CCA is successfully executed on a last OFDM symbol in the previous subframe of the subframe or the scheduling subframe, sending the PUSCH and the SRS on the subframe or the scheduling subframe; or
when the LBT or CCA is successfully executed on a last OFDM symbol in the previous time slot of the time slot, sending the PUSCH and the SRS on the time slot,
wherein a transmission starting moment of the PUSCH comprises a first OFDM symbol in the scheduling subframe or the time slot; or
wherein the location for sending the SRS comprises a last OFDM symbol in the scheduling subframe or the time slot.

29. (canceled)

30. (canceled)

31. The method according to claim 1, further comprising:
when the location for sending the SRS and a location for executing the LBT or CCA detection of next subframe or time slot are in the same OFDM symbol, the location for sending the SRS and the location for executing the LBT or CCA detection of the next subframe or time slot coexist in a frequency division manner,
wherein the location of the LBT or CCA detection is one of frequency-domain location sets of the SRS.

32.-36. (canceled)

37. The method according to claim 28, further comprising: after the LBT or CCA is successfully executed on the last OFDM symbol in the previous subframe of the scheduling subframe,
sending, by first UE or UE group, the PUSCH on the scheduling subframe and sending, by second UE or UE group, the SRS on a last symbol in the scheduling subframe or a candidate subframe; or,
sending, by first UE or UE group, the PUSCH on the scheduling subframe or the candidate subframe and sending, by second UE or UE group, the SRS on the last symbol of the subframe; or
sending, by first UE or UE group, the PUSCH on the scheduling subframe or the candidate subframe and sending, by the first UE or UE group, the SRS on the last symbol of the subframe; or
sending, by first UE or UE group, the PUSCH on the scheduling subframe or the candidate subframe and sending, by both second UE or UE group and the first UE or UE group, the SRS on the last symbol of the subframe; or
sending, by first UE or UE group, the PUSCH on the scheduling subframe and sending, by second UE or UE group, the SRS on a first symbol in the scheduling subframe or the candidate subframe; or
sending, by first UE or UE group, the PUSCH on the scheduling subframe or the candidate subframe and sending, by second UE or UE group, the SRS on the first symbol of the subframe; or
sending, by first UE or UE group, the PUSCH on the scheduling subframe or the candidate subframe and sending, by the first UE or UE group, the SRS on the first symbol of the subframe; or
sending, by first UE or UE group, the PUSCH on the scheduling subframe or the candidate subframe and sending, by both second UE or UE group and the first UE or UE group, the SRS on the first symbol of the subframe.

38. (canceled)

39. (canceled)

40. The method according to claim 37, further comprising: before sending, by the second UE or UE group, the SRS,
executing the LBT or CCA detection; or,
making no execution of the LBT or CCA detection,
wherein determining not to execute the LBT or CCA detection executed for SRS sending of the second UE or UE group comprises one of the following:
determining to send the SRS on the candidate subframe or time slot according to an indication of the eNB;
determining whether to send the SRS or not according to an indication of the eNB on each subframe or time slot; or,
determining as a default to send the SRS on the candidate subframe or time slot and determining the subframe or time slot for sending the SRS according to the indication of the eNB or triggering of new signaling.

41.-49. (canceled)

50. The method according to claim 1, further comprising:
when the right to use the unlicensed carrier is not obtained by contention, stopping sending the SRS on a first predetermined time-domain resource, executing the LBT or CCA detection before a second predetermined time-domain resource after the first predetermined time-domain resource of the unlicensed carrier, and when the LBT is successfully executed before the second predetermined time-domain resource, sending the SRS on the second predetermined time-domain resource; or,
when the right to use the unlicensed carrier is not obtained by contention, stopping sending the SRS on a first predetermined time-domain resource, executing the LBT or CCA detection before a third predetermined time-domain resource in a time window for sending the SRS on the unlicensed carrier, and when the LBT is successfully executed before the third predetermined time-domain resource, sending the SRS on the third predetermined time-domain resource; or,
when the right to use the unlicensed carrier is not obtained by contention, stopping sending the SRS on a first predetermined time-domain resource, continuing contending for the right to use the unlicensed carrier on the unlicensed carrier, and when the unlicensed carrier is obtained by contention, sending the SRS, or
wherein a complemental location for sending the SRS is located before the first predetermined time-domain resource, or after the first predetermined time-domain resource, or comprises the first predetermined time-domain resource.

51.-53. (canceled)

54. The method according to claim 1, wherein at least one of a time-domain location for executing the LBT or CCA detection, a frequency-domain location for executing the LBT or CCA detection, a time-domain location for sending the SRS, a frequency-domain location for sending the SRS, a location of the time window for sending the SRS, a candidate time-domain location for sending the SRS, a candidate frequency-domain location for sending the SRS, or the transmission starting moment of the PUSCH is acquired in the following manner:
predetermining by the eNB and the UE; or,
indicating to the UE by the eNB; or,
notifying through physical-layer signaling; or,
notifying through high-layer radio link control signaling; or,
predefining.

55. (canceled)

56. A device for sending an sounding reference signal (SRS), arranged in a first communication node, and the device comprising a processor and a memory storing computer-readable operation instructions, wherein when the computer-readable operation instructions in the memory are run, the processor is configured to:
contend for a right to user an unlicensed carrier according to a listen before talk (LBT) or a clear channel assessment (CCA) detection; and
when the contention for the right to use the unlicensed carrier is successful, send at least one of an SRS or a physical uplink shared channel (PUSCH) on the unlicensed carrier.

57.-64. (canceled)

65. A method for sending a sounding reference signal (SRS), comprising:
acquiring, by a communication node, configuration information comprising an SRS frequency-domain pattern set; and
sending, by the communication node, an SRS according to the configuration information.

66. The method according to claim 65, wherein the SRS frequency-domain pattern set comprises: a listen before talk (LBT) or a clear channel assessment (CCA) detection frequency-domain pattern,
wherein the LBT or the CCA detection frequency-domain pattern comprises:
a frequency-domain pattern within the SRS frequency-domain pattern set; or
an SRS frequency-domain pattern; or,
a resource pattern with a certain interval on part of or all of resources on a whole bandwidth.

67. (canceled)

68. The method according to claim 66, further comprising:
executing, by the communication node, the LBT or the CCA detection on a frequency resource corresponding to the frequency-domain pattern in the SRS frequency-domain pattern set.

69. The method according to claim 65, wherein sending, by the communication node, the SRS according to the configuration information comprises:
sending, by the communication node, the SRS on an SRS frequency-domain location corresponding to at least one of remaining SRS frequency-domain patterns except for the LBT or the CCA detection frequency-domain pattern in the SRS frequency-domain pattern set.

70. The method according to claim 65, wherein acquiring the configuration information comprising the SRS frequency-domain pattern set comprises:
predetermining the configuration information by an eNB and the communication node; or,
indicating the configuration information to the communication node by an eNB; or,
notifying the communication node of the configuration information through physical-layer downlink control information signaling; or,
notifying the communication node of the configuration information through high-layer radio link control signaling; or,
predefining the configuration information.
